(19) United States
(12) Patent Application Publication
(10) Pub. No.: US 2004/0057617 A1
(43) Pub. Date: Mar. 25, 2004

(54) Image data supply method, recording apparatus and program

(75) Inventors: Kouji Miyawaki, Tokyo (JP); Tsukasa Ito, Tokyo (JP); Takeshi Nakajima, Tokyo (JP); Hiroaki Takano, Tokyo (JP); Chizuko Ikeda, Tokyo (JP); Yumiko Nakatsuru, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Corporation, Tokyo (JP)

(21) Appl. No.: 10/663,505

(22) Filed: Sep. 15, 2003

(30) Foreign Application Priority Data
Sep. 20, 2002 (JP) JP2002-275649

(51) Int. Cl. G06F 15/16; G06K 1/00; G06F 15/00; B41J 1/00

(52) U.S. Cl. 382/167; 358/1.18; 709/203

(57) ABSTRACT

There is described a method for providing processed image data to a client, who requests an image-processing service from an image-processing service provider. The processed image data are generated by processing an original image submitted by the client as an object of the image-processing service. The method includes the steps of acquiring original image data, which include expanded color-range image data, from the original image; determining a first optimizing condition for generating output-referred image data from device characteristic data in respect to the output device, in order to generate optimizing condition data; storing the original image data including the expanded color-range image data and the optimizing condition data, while correlating them; and providing the original image data including the expanded color-range image data and the first optimizing condition data, stored in the storing step, to the client, based on a providing procedure established in advance.

### BACKGROUND OF THE INVENTION

The present invention relates to an image data providing method, an image-recording apparatus and a computer program for controlling the image-recording apparatus.

Conventionally, the direct exposing method, in which an image of a photographic film is projected onto a photographic paper, is employed for the print production process by developing the photographic film.

Recently, in contrast to the abovementioned method, there has been put in practical use the digital photo printer in which the image of the photographic film is photo-electronically read and converted to digital image data, and then, various kinds of image-processing are applied to the digital image data so as to create processed image data for recording operation, and further, a photosensitive material is exposed by scanning the recoding light modulated according to the processed image data so as to output a printed image.

According to the digital photo printer mentioned above, since it is possible to apply a suitable image-processing (optimization) to the image data, it becomes possible to obtain a high-quality print, which cannot be obtained through the conventional direct exposing method, by optimally conducting the gradation adjustment, the color-balance adjustment, color/density adjustment, etc.

In the above case, since the original image is converted to digital image data, it becomes possible to printout not only the image captured on the photographic film, but also the image data captured by the digital camera, etc., and other image data acquired through a communication means, such as the Internet, etc.

Further, in this case, the digital image data captured by an image-capturing apparatus is distributed through such a memory device as a CD-R (Compact Disk Recordable), floppy disk (registered trade name) and memory card or the Internet, and is displayed on such a display monitor as a CRT (Cathode Ray Tube), liquid crystal display and plasma display or a small-sized liquid crystal monitor display device of a cellular phone, or is printed out as a hard copy image using such an output device as a digital printer, inkjet printer and thermal printer. In this way, display and print methods have been diversified in recent years.

When digital image data is displayed and outputted for viewing purpose, it is a common practice to provide various types of image processing typically represented by gradation adjustment, brightness adjustment, color balancing and enhancement of sharpness to ensure that a desired image quality is obtained on the display monitor used for viewing or on the hard copy.

In order to cope with such varied display and printing methods, efforts have been made to improve the general versatility of digital image data captured by an image-capturing apparatus. As part of these efforts, an attempt has been made to standardize the color space represented by digital RGB (Red, Green and Blue) signals into the color space that does not depend on characteristics of an image-capturing apparatus. At present, large amounts of digital image data have adopted the sRGB (See Multimedia Systems and Equipment—Color Measurement and Management—Part 2-1: Color Management—Default RGB Color Space—sRGB″ IEC61966-2-1) as a standardized color space. The color space of this sRGB has been established to meet the color reproduction area for a standard CRT display monitor.

The image displayed on such a display device as a CRT display monitor and the hard copy image printed by various printing devices have different color reproduction areas depending on the configuration of the phosphor or color material to be used. For example, the color reproduction area of the CRT display monitor corresponding to the sRGB standard space has a wide bright green and blue area. It contains the area that cannot be reproduced by the hard copy formed by a silver halide photographic printer, inkjet printer and conventional printer. Conversely, the cyan area of the conventional printing or inkjet printing and the yellow area of the silver halide photographic printing contain the area that cannot be reproduced by the CRT display monitor corresponding to the sRGB standard color space. (For example, see “Fine imaging and digital photographing” edited by the Publishing Commission of the Japan Society of Electrophotography, Corona Publishing Co., P. 444). In the meantime, some of the scenes of the subject to be photographed may contain the color in the area that cannot be reproduced in any of these areas for color reproduction.

As described above, the color space (including the sRGB) optimized on the basis of display and printing by a specific device is accompanied by restrictions in the color gamut where recording is possible. So when recording the information picked up by a photographing device, it is necessary to make adjustment of mapping by compressing the information into the color gamut where recording is allowed. The simplest way is provided by clipping where the color chromaticity point outside the color gamut where recording is possible is mapped onto the boundary of the nearest color gamut. This causes the gradation outside the color gamut to be collapsed, and the image will give a sense of incompatibility to the viewer. To avoid this problem, non-liner compression method is generally used. In this method, the chromaticity point in the area where chroma is high in excess of an appropriate threshold value is compressed smoothly according to the size of the chroma. As a result, chroma is compressed and recording is carried out even at the chromaticity point inside the color gamut where recording is possible. (For the details of the procedure of mapping the color gamut, see “Fine imaging and digital photographing” edited by the Publishing Commission of the Japan Society of Electrophotography, Corona Publishing Co., P. 447, for example).

The image displayed on such a display device as a CRT display monitor, the hard copied image printed by various types of printing devices, or color space (including sRGB) optimized on the basis of display and printing by these devices are restricted to the conditions where the area of brightness that allows recording and reproduction is of the order of about 100 to 1. By contrast, however, the scene of the subject to be photographed has a wide area of brightness, and it often happens that the order of several thousands to 1 is reached outdoors. (See “Handbook on Science of Color, New Version, 2nd Print” by Japan Society for Science of Colors, Publishing Society of the University of Tokyo, P. 926, for example). Accordingly, when recording the information gained by the image capturing device, compression is also necessary for brightness. In this processing, adequate conditions must be set for each image in conformity to the dynamic range of the scene to be photographed, and the range of brightness for the main subject in the scene to be photographed.

However, compressed gradation information and/or clipped information are immediately lost at the time when compression has been carried out for the color gamut and brightness area as described above, due to the principle of the digital image to be recorded in terms of the discrete value. Accordingly, the original state cannot be recovered. This imposes a big restriction on the general versatility of high-quality digital image.

For example, when the printing device prints the image recorded in the sRGB standard color space, mapping must be carried out again based on the differences between the sRGB standard color space and the area for color reproduction of the printing device. For the image recorded in the sRGB standard color space, however, the information on gradation in the area compressed at a time of recording is lost. So the smoothness of gradation is deteriorated as compared to the case where the information captured by the photographing device is mapped directly in the area for color reproduction of the printing device. Further, if gradation compression conditions are not adequate at a time of recording, and there are problems such as a whitish picture, dark face, deformed shadow and conspicuous white skipping in the highlighted area, improvement is very inadequate as compared to the case where the new image is created again from the information gained by the photographing device, even if the gradation setting is changed to improve the image. This is because information on gradation prior to compression, and information on the portion subjected to deformation or white skipping have been already lost.

As a solution of the above-mentioned problems, the art of storing the process of image editing as a backup data without extremely increasing the data amount and returning it to the state prior to editing as needed has long been known. For example, there has been proposed a backup device wherein, when the digital image is subjected to local modification by image processing, the image data on the difference between the digital image data before image processing and that after image processing is saved as backup data (for instance, set forth in Patent Document No.1 indicated later). Further, there has been also proposed a method for recovering the digital image data before editing, by saving the image data on the difference between the digital image data before image processing and that after image processing (for instance, set forth in Patent Document No.2 indicated later).

Incidentally, if the information on the wide color gamut and brightness area gained by a photographing device is recorded as scene-referred image data that is not compressed, then inadvertent loss of information can be prevented. The standard color space suited to record such scene-referred image data is proposed, for example, by RIMM RGB (Reference Input Medium Metric RGB) and ERIMM RGB (Extended Reference Input Medium Metric RGB) (See the Journal of Imaging Science and Technology, Vol. 45 p p. 418 to 426 (2001)).

Further, there has been disclosed an image processing apparatus characterized by two modes; a mode of recording in the form of an image signal displayed on the display means and a mode of recording in the form of captured image signal (for instance, set forth in Patent Document No.3 indicated later). The form of image signal in the latter case is generally called RAW data. Using the special-purpose application software (called “development software”), such digital image data can be converted into output-referred image data of the above-mentioned Exif file or the like for display or printing (called “electronic development” or simply “development”). Since the RAW data retains all information at a time of photographing, it permits output-referred image data to be remade. If other color system files such as CMYK are created directly, there will no inadvertent modification of the color system due to the difference in color gamut from the display monitor (sRGB).

However, the RAW data is recorded according to the color space based on the spectral sensitivity characteristics inherent to the type of a photographing apparatus and the file format inherent to the type of a photographing apparatus. Accordingly, image suitable to display and printing can be obtained only when special-purpose development software inherent to the type of the photographing apparatus is used.

<Indication of Cited Patent Document>

[Patent Document No.1]

Tokkaihei 07-57074 (Pages 4-7, FIGS. 5-6)

[Patent Document No.2]

Tokkai 2001-94778 (Pages 4-8, FIGS. 1-2)

[Patent Document No.1]

Tokkaihei 11-261933 (Pages 4-11, FIGS. 2-4)

Still further, even if the image before applying the image-processing can be reconstructed by employing the abovementioned conventional methods, it is quite difficult to create such the finished image that conforms with tastes of each user (namely, each of clients who request the image-processing service from the image-processing service provider), and further, it is quite difficult to create such the finished image that conforms with the characteristics of the output device, such as color range, etc.

### SUMMARY OF THE INVENTION

To overcome the abovementioned drawbacks in conventional image-recording apparatus, it is an object of the present invention to provide image-data providing methods, image-recording apparatus and computer programs, that make it possible to produce a high quality print, which is finished by reflecting the user's tastes.

Accordingly, to overcome the cited shortcomings, the abovementioned object of the present invention can be attained by image-data providing methods, image-recording apparatus and computer programs, described as follow.

(1) A method for providing processed image data to a client, who requests an image-processing service from an image-processing service provider, the processed image data being generated by processing an original image submitted by the client as an object of the image-processing service, so as to conform with device characteristics of an output device, the method comprising the steps of: acquiring original image data, which include expanded color-range image data, from the original image; determining a first optimizing condition, serving as a first rendering condition, for generating first output-referred image data from device characteristic data in respect to a first output device and the original image data including the expanded color-range image data, in order to generate first optimizing condition data; storing the original image data including the expanded color-range image data and the first optimizing condition data, representing the first optimizing condition, while correlating them; and providing the original image data including the expanded color-range image data and the first optimizing condition data, stored in the storing step, to the client, based on a providing procedure established in advance.

(2) The method of item 1, wherein, in the storing step, the first optimizing condition data are stored as tag information of the expanded color-range image data.

(3) The method of item 1, further comprising the step of: generating reduced image data, being suitable for the output device, from the original image data and either the first optimizing condition data or other optimizing condition data, so that a size of the reduced image data becomes smaller than that of the expanded color-range image data; wherein, in the storing step, the reduced image data are stored while being correlated with the original image data and/or the first optimizing condition data.

(4) The method of item 3, further comprising the step of: generating first differential image data, which represent a difference between the expanded color-range image data and the reduced image data; wherein, in the storing step, the first differential image data are stored while being correlated with the reduced image data.

(5) The method of item 4, wherein, in the storing step, the first differential image data are stored as tag information of the reduced image data.

(6) The method of item 1, wherein the first output device is a printer equipped at the image-processing service provider or another print service provider.

(7) The method of item 1, wherein the first output device is a printer equipped at a site of the client who requests the image-processing service from the image-processing service provider.

(8) The method of item 1, further comprising the step of: setting an output device designated by the client as the first output device.

(9) The method of item 1, further comprising the step of: generating the first output-referred image data from the original image data, based on the first optimizing condition; wherein, in the storing step, the first output-referred image data are stored while being correlated with the original image data including the expanded color-range image data and/or the first optimizing condition data.

(10) The method of item 9, wherein, in the storing step, the first optimizing condition data are stored as tag information of the first output-referred image data.

(11) The method of item 9, further comprising the step of: generating second differential image data, which represent a difference between the expanded color-range image data and the first output-referred image data; wherein, in the storing step, the second output-referred image data are stored while being correlated with the first output-referred image data.

(12) The method of item 9, wherein, in the determining step, a second optimizing condition, serving as a second rendering condition, for generating second output-referred image data from second device characteristic data in respect to a second output device and the original image data including the expanded color-range image data, is determined; and wherein, in the generating step, the second output-referred image data are generated from the original image data, based on the second optimizing condition; and wherein, in the storing step, the first output-referred image data are stored while being correlated with the second output-referred image data.

(13) The method of item 12, further comprising the step of: generating third differential image data, which represent a difference between the first output-referred image data and the second output-referred image data; wherein, in the storing step, the third differential image data are stored while being correlated with the second output-referred image data.

(14) The method of item 1, further comprising the step of: producing a first print having a first image formed on a printing medium by the first output device, based on the first output-referred image data; wherein, during the producing step, the first output-referred image data are correlated with the original image data and the first optimizing condition.

(15) The method of item 14, wherein, in the determining step, a third optimizing condition, which is different from the first optimizing condition in respect to at least one processing condition and/or a processing order, is determined; and wherein, in the generating step, third output-referred image data are generated from the original image data, based on the third optimizing condition; and wherein, in the producing step, the first output device produces a second print by forming a second image on the printing medium, based on the third output-referred image data.

(16) The method of item 15, wherein, in the producing step, the first output device produces the second print by forming the second image on the printing medium, based on a difference between the first output-referred image data and the third output-referred image data.

(17) The method of item 15, wherein, in the producing step, the first output device produces the second print by forming both the first image and the second image on the printing medium.

(18) The method of item 15, wherein, in the producing step, the first output device produces the second print by forming a reduced image, which is obtained by reducing a third image formed from the third output-referred image data, on the printing medium.

(19) The method of item 15, further comprising the step of: trimming a part of a third image formed from the third output-referred image data; wherein, in the producing step, the first output device produces the second print by forming the third image, the part of which is trimmed in the trimming step, on the printing medium, based on the third output-referred image data.

(20) The method of item 1, wherein, in the storing step, the original image data, including the expanded color-range image data, and the first optimizing condition data are stored in a computer-readable storage medium, while correlating them with each other.

(21) The method of item 1, wherein, in the storing step, the original image data, including the expanded color-range image data, and the first optimizing condition data are stored in a server coupled to a communication network, while correlating them with each other.

(22) The method of item 1, wherein, in the storing step, an optimization processing program, for acquiring a fourth optimizing condition, based on the original image data including expanded color-range image data and the first optimizing condition, is stored in a computer-readable storage medium.

(23) The method of item 22, wherein, in the storing step, the optimization processing program, for generating and storing a fourth output-referred image data, based on the original image data including expanded color-range image data and the fourth optimizing condition data, is stored in the computer-readable storage medium.

(24) The method of item 23, wherein, in the storing step, the optimization processing program, for storing the fourth output-referred image data while correlating the fourth output-referred image data with the original image data including the expanded color-range image data and/or the first optimizing condition data, is stored in the computer-readable storage medium.

(25) The method of item 22, wherein, in the storing step, the optimization processing program, for storing the fourth optimizing condition data while correlating the fourth optimizing condition data with the original image data including the expanded color-range image data and/or the first optimizing condition data, is stored in the computer-readable storage medium.

(26) The method of item 1, wherein, in the acquiring step, scene-referred image data, which are standardized from scene-referred raw data, including device characteristics of an image-capturing apparatus, by compensating for the device characteristics, are acquired as the expanded color-range image data; and wherein, in the storing step, the scene-referred image data and the first optimizing condition are stored while being correlated with each other.

(27) An apparatus for generating data, which are employed for acquiring processed image data suitable for device characteristics of an output device from an original image, in order to store the data in it, the apparatus comprising: an acquiring section to acquire original image data, which include expanded color-range image data, from the original image; a determining section to determine a first optimizing condition, serving as a first rendering condition, for generating first output-referred image data from device characteristic data in respect to a first output device and the original image data including the expanded color-range image data, in order to generate first optimizing condition data; and a storing section to store the original image data including the expanded color-range image data and the first optimizing condition data, representing the first optimizing condition, while correlating them.

(28) The apparatus of item 27, wherein the storing section stores the first optimizing condition data as tag information of the expanded color-range image data.

(29) The apparatus of item 27, further comprising: a reduced image data generating section to generate reduced image data, being suitable for the output device, from the original image data and either the first optimizing condition data or other optimizing condition data, so that a size of the reduced image data becomes smaller than that of the expanded color-range image data; wherein the storing section stores the reduced image data while correlating the reduced image data with the original image data and/or the first optimizing condition data.

(30) The apparatus of item 29, further comprising: a first differential image data generating section to generate first differential image data, which represent a difference between the expanded color-range image data and the reduced image data; wherein the storing section stores the first differential image data while correlating the first differential image data with the reduced image data.

(31) The apparatus of item 29, wherein the storing section stores the first differential image data as tag information of the reduced image data.

(32) The apparatus of item 27, wherein the first output device is a printer equipped at an image-processing service provider or another print service provider.

(33) The apparatus of item 27, wherein the first output device is a printer equipped at a site of a client who requests an image-processing service from an image-processing service provider.

(34) The apparatus of item 27, further comprising: an output device setting section to set an output device, designated by a client who requests an image-processing service from an image-processing service provider, as the first output device.

(35) The apparatus of item 27, further comprising: an output-referred image data generating section to generate the first output-referred image data from the original image data, based on the first optimizing condition; wherein the storing section stores the first output-referred image data while correlating the first output-referred image data with the original image data including the expanded color-range image data and/or the first optimizing condition data.

(36) The apparatus of item 35, wherein the storing section stores the first optimizing condition data as tag information of the first output-referred image data.

(37) The apparatus of item 35, further comprising: a differential image data generating section to generate second differential image data, which represent a difference between the expanded color-range image data and the first output-referred image data; wherein the storing section stores the second output-referred image data while correlating the second output-referred image data with the first output-referred image data.

(38) The apparatus of item 35, wherein the determining section determines a second optimizing condition, serving as a second rendering condition, for generating second output-referred image data from second device characteristic data in respect to a second output device and the original image data including the expanded color-range image data; and wherein the output-referred image data generating section generates the second output-referred image data from the original image data, based on the second optimizing condition; and wherein the storing section stores the first output-referred image data while correlating the first output-referred image data with the second output-referred image data.

(39) The apparatus of item 38, further comprising: a differential image data generating section to generate third differential image data, which represent a difference between the first output-referred image data and the second output-referred image data; wherein the storing section stores the third differential image data while correlating the third differential image data with the second output-referred image data.

(40) The apparatus of item 27, further comprising: a print producing section to produce a first print having a first image formed on a printing medium by the first output device, based on the first output-referred image data; wherein, during producing the first print, the print producing section correlates the first output-referred image data with the original image data and the first optimizing condition.

(41) The apparatus of item 40, wherein the determining section determines a third optimizing condition, which is different from the first optimizing condition in respect to at least one processing condition and/or a processing order; and wherein the output-referred image data generating section generates third output-referred image data from the original image data, based on the third optimizing condition; and wherein the print producing section makes the first output device to produce a second print by forming a second image on the printing medium, based on the third output-referred image data.

(42) The apparatus of item 41, wherein the print producing section makes the first output device to produce the second print by forming the second image on the printing medium, based on a difference between the first output-referred image data and the third output-referred image data.

(43) The apparatus of item 41, wherein the print producing section makes the first output device to produce the second print by forming both the first image and the second image on the printing medium.

(44) The apparatus of item 41, wherein the print producing section makes the first output device to produce the second print by forming a reduced image, which is obtained by reducing a third image formed from the third output-referred image data, on the printing medium.

(45) The apparatus of item 41, further comprising: a trimming section to trim a part of a third image formed from the third output-referred image data; wherein the print producing section makes the first output device to produce the second print by forming the third image, the part of which is trimmed by the trimming section, on the printing medium, based on the third output-referred image data.

(46) The apparatus of item 27, wherein the storing section stores the original image data, including the expanded color-range image data, and the first optimizing condition data in a computer-readable storage medium, while correlating them with each other.

(47) The apparatus of item 27, wherein the storing section stores the original image data, including the expanded color-range image data, and the first optimizing condition data in a server coupled to a communication network, while correlating them with each other.

(48) The apparatus of item 27, wherein the storing section stores an optimization processing program, for acquiring a fourth optimizing condition, based on the original image data including expanded color-range image data and the first optimizing condition, in a computer-readable storage medium.

(49) The apparatus of item 48, wherein the storing section stores the optimization processing program, for generating and storing a fourth output-referred image data, based on the original image data including expanded color-range image data and the fourth optimizing condition data, in the computer-readable storage medium.

(50) The apparatus of item 49, wherein the storing section stores the optimization processing program, for storing the fourth output-referred image data while correlating the fourth output-referred image data with the original image data including the expanded color-range image data and/or the first optimizing condition data, in the computer-readable storage medium.

(51) The apparatus of item 48, wherein the storing section stores the optimization processing program, for storing the fourth optimizing condition data while correlating the fourth optimizing condition data with the original image data including the expanded color-range image data and/or the first optimizing condition data, in the computer-readable storage medium.

(52) The apparatus of item 1, wherein the acquiring section acquires scene-referred image data, which are standardized from scene-referred raw data including device characteristics of an image-capturing apparatus by compensating for the device characteristics, as the expanded color-range image data; and wherein the storing section stores the scene-referred image data and the first optimizing condition while correlating them with each other.

(53) A computer program for executing controlling-operations for generating and storing data, which are employed for acquiring processed image data suitable for device characteristics of an output device from an original image, the computer program comprising the functional steps of: acquiring original image data, which include expanded color-range image data, from the original image; determining a first optimizing condition, serving as a first rendering condition, for generating first output-referred image data from device characteristic data in respect to a first output device and the original image data including the expanded color-range image data, in order to generate first optimizing condition data; and storing the original image data including the expanded color-range image data and the first optimizing condition data, representing the first optimizing condition, while correlating them.

(54) The computer program of item 53, wherein, in the storing step, the first optimizing condition data are stored as tag information of the expanded color-range image data.

(55) The computer program of item 53, further comprising the functional step of: generating reduced image data, being suitable for the output device, from the original image data and either the first optimizing condition data or other optimizing condition data, so that a size of the reduced image data becomes smaller than that of the expanded color-range image data; wherein, in the storing step, the reduced image data are stored while being correlated with the original image data and/or the first optimizing condition data.

(56) The computer program of item 55, further comprising the functional step of: generating first differential image data, which represent a difference between the expanded color-range image data and the reduced image data; wherein, in the storing step, the first differential image data are stored while being correlated with the reduced image data.

(57) The computer program of item 56, wherein, in the storing step, the first differential image data are stored as tag information of the reduced image data.

(58) The computer program of item 53, wherein the first output device is a printer equipped at an image-processing service provider or another print service provider.

(59) The computer program of item 53, wherein the first output device is a printer equipped at a site of a client who requests an image-processing service from an image-processing service provider.

(60) The computer program of item 53, further comprising the functional step of: setting an output device designated by the client as the first output device.

(61) The computer program of item 53, further comprising the functional step of: generating the first output-referred image data from the original image data, based on the first optimizing condition; wherein, in the storing step, the first output-referred image data are stored while being correlated with the original image data including the expanded color-range image data and/or the first optimizing condition data.

(62) The computer program of item 61, wherein, in the storing step, the first optimizing condition data are stored as tag information of the first output-referred image data.

(63) The computer program of item 61, further comprising the functional step of: generating second differential image data, which represent a difference between the expanded color-range image data and the first output-referred image data; wherein, in the storing step, the second output-referred image data are stored while being correlated with the first output-referred image data.

(64) The computer program of item 61, wherein, in the determining step, a second optimizing condition, serving as a second rendering condition, for generating second output-referred image data from second device characteristic data in respect to a second output device and the original image data including the expanded color-range image data, is determined; and wherein, in the generating step, the second output-referred image data are generated from the original image data, based on the second optimizing condition; and wherein, in the storing step, the first output-referred image data are stored while being correlated with the second output-referred image data.

(65) The computer program of item 64, further comprising the functional step of: generating third differential image data, which represent a difference between the first output-referred image data and the second output-referred image data; wherein, in the storing step, the third differential image data are stored while being correlated with the second output-referred image data.

(66) The computer program of item 53, further comprising the functional step of: producing a first print having a first image formed on a printing medium by the first output device, based on the first output-referred image data; wherein, during the producing step, the first output-referred image data are correlated with the original image data and the first optimizing condition.

(67) The computer program of item 66, wherein, in the determining step, a third optimizing condition, which is different from the first optimizing condition in respect to at least one processing condition and/or a processing order, is determined; and wherein, in the generating step, third output-referred image data are generated from the original image data, based on the third optimizing condition; and wherein, in the producing step, the first output device produces a second print by forming a second image on the printing medium, based on the third output-referred image data.

(68) The computer program of item 67, wherein, in the producing step, the first output device produces the second print by forming the second image on the printing medium, based on a difference between the first output-referred image data and the third output-referred image data.

(69) The computer program of item 67, wherein, in the producing step, the first output device produces the second print by forming both the first image and the second image on the printing medium.

(70) The computer program of item 67, wherein, in the producing step, the first output device produces the second print by forming a reduced image, which is obtained by reducing a third image formed from the third output-referred image data, on the printing medium.

(71) The computer program of item 67, further comprising the step of: trimming a part of a third image formed from the third output-referred image data; wherein, in the producing step, the first output device produces the second print by forming the third image, the part of which is trimmed in the trimming step, on the printing medium, based on the third output-referred image data.

(72) The computer program of item 53, wherein, in the storing step, the original image data, including the expanded color-range image data, and the first optimizing condition data are stored in a computer-readable storage medium, while correlating them with each other.

(73) The computer program of item 53, wherein, in the storing step, the original image data, including the expanded color-range image data, and the first optimizing condition data are stored in a server coupled to a communication network, while correlating them with each other.

(74) The computer program of item 53, wherein, in the storing step, an optimization processing program, for acquiring a fourth optimizing condition, based on the original image data including expanded color-range image data and the first optimizing condition, is stored in a computer-readable storage medium.

(75) The computer program of item 74, wherein, in the storing step, the optimization processing program, for generating and storing a fourth output-referred image data, based on the original image data including expanded color-range image data and the fourth optimizing condition data, is stored in the computer-readable storage medium.

(76) The computer program of item 75, wherein, in the storing step, the optimization processing program, for storing the fourth output-referred image data while correlating the fourth output-referred image data with the original image data including the expanded color-range image data and/or the first optimizing condition data, is stored in the computer-readable storage medium.

(77) The computer program of item 74, wherein, in the storing step, the optimization processing program, for storing the fourth optimizing condition data while correlating the fourth optimizing condition data with the original image data including the expanded color-range image data and/or the first optimizing condition data, is stored in the computer-readable storage medium.

(78) The computer program of item 53, wherein, in the acquiring step, scene-referred image data, which are standardized from scene-referred raw data, including device characteristics of an image-capturing apparatus, by compensating for the device characteristics, are acquired as the expanded color-range image data; and wherein, in the storing step, the scene-referred image data and the first optimizing condition are stored while being correlated with each other.

Further, to overcome the abovementioned problems, other image-data providing methods, image-recording apparatus and computer programs, embodied in the present invention, will be described as follow:

(79) An image data providing method for providing image data suitable for device characteristics of an output device from an original image, serving as an object of the image-processing service, to a client who requests an image-processing service from an image-processing service provider, characterized by comprising the steps of:

acquiring data including expanded color-range image data from the original image;

determining a first optimizing condition for generating first output-referred image data from device characteristic data in respect to a first output device and the data including the expanded color-range image data;

recording the data including the expanded color-range image data and the first optimizing condition data while correlating them with each other; and

providing the data including the expanded color-range image data and the first optimizing condition data, recorded in the recording step, to the client, based on a providing procedure established in advance.

The image data recorded in an sRGB standard color space provided by prior-art image processing services is characterized in that the color range and brightness range are compressed so as to conform to the display color range of the display monitor. It has been difficult to make improvements in order to cope with the gradation failure that may occur when mapping onto the color reproduction area of a print device, or several other failures that may occur due to gradation compression conditions during recording. According to the present invention described in item 1 or item 79, by contrast, the expanded color-range image obtained from an original image is recorded, thereby ensuring generation of an image compatible with a great variety of output devices including a print device.

Further, the first optimization processing (hereinafter referred to as “rendering”) condition (hereinafter referred to as “rendering condition”) for generating the first output-referred image data (hereinafter referred to as “reference output-referred image data”) is recorded as the first optimization processing condition data (hereinafter referred to as “reference rendering information”) in the form associated with expanded color-range image data, and is provided to a client. Thus, by referring to the rendering condition provided as reference rendering information, the client can easily set the desired rendering condition to his or her preference through the step of increasing or decreasing a condition parameter. The output-referred image data, generated by applying processing of rendering to the expanded color-range image data based on the above-mentioned client setting, is outputted onto such an output device as a print device, whereby a high-quality image print desired by the client can be outputted.

(80) The image data providing method, described in item 79, characterized in that,

in the recording step, the first optimizing condition data are recorded as tag information of the expanded color-range image data.

According to the present invention described in item 2 or item 80, the reference rendering information is recorded as tag information (meta-data) of the expanded color-range image data so as to reduce the possibility of association between two pieces of information being lost and to ensure a stable supply of information to the client.

(81) The image data providing method, described in item 79 or item 80, further comprising the step of:

generating reduced image data, being suitable for the output device, from the data including the expanded color-range image data and either the first optimizing condition data or other optimizing condition data, so that a size of the reduced image data becomes smaller than that of the expanded color-range image data;

characterized in that, in the recording step, the reduced image data are recorded while being correlated with the data including the expanded color-range image data and/or the first optimizing condition data.

According to the present invention described in item 3 or item 81, the reduced image data as output-referred image data compatible with the output device is recorded in the form associated with the data including the expanded color-range image data and/or reference rendering information. This makes it possible for the client to select an image as an object of processing, namely the data including the expanded color-range image data recorded by association, and reference rendering information, by outputting reduced image data to an output device or the like. Further, even if the data including the expanded color-range image data cannot be used in the environment for each client, the data can be outputted to an output device corresponding to the reduced image data so that it can be used.

Further, reference rendering information is recorded as the tag information (meta-data) of reduced image data, thereby reducing the possibility of association between two pieces of information being lost and ensuring a stable supply of information to the client.

It is also possible to make such arrangements that the output-referred image data compatible with the output device is the reference output-referred image data compatible with a reference output device, or the output-referred image data compatible with the output device other than reference output device. A display monitor is suitably used as an output device other than reference output device, and the sRGB image data and thumbnail image are suitably used as the output-referred image data.

(82) The image data providing method, described in item 81, further comprising the step of:

generating first differential image data, which represent a difference between the expanded color-range image data and the reduced image data;

characterized in that, in the recording step, the first differential image data are recorded while being correlated with the reduced image data.

According to the present invention described in item 4 or item 82, since the first differential image is recorded in a state associated with the reduced image data of small size, it can be supplied to the client after the amount of the expanded color-range image data has been reduced.

The reduced image data can be reference output-referred image data compatible with a reference output device or output-referred image data compatible with the output device other than the reference output device. It is more preferred if it is an sRGB image data compatible with a display monitor.

(83) The image data providing method, described in item 81 or item 82, characterized in that,

in the recording step, the first differential image data are recorded as tag information of the reduced image data.

According to the present invention described in item 5 or item 83, the first differential image data is recorded as the tag information of the reduced image data (meta-data). This feature reduces the possibility of the association between expanded color-range image data and reduced image data, and ensures a stable supply of information to the client.

(84) The image data providing method, described in anyone of items 79-83, characterized in that,

the first output device is a printer equipped at the image-processing service provider or another print service provider.

According to the present invention described in item 6 or item 84, the reference rendering information is recorded while the printer of an image processing service provider or other print service provider is used as a reference output device. This allows a client to change the image data in conformity to his or her preference, based on the reference rendering information compatible with the printer of an image processing service provider or other print service provider. The updated image data is image data compatible with the print output from a printer provided by an image processing service provider other print service provider. Thus, a high quality print finished in conformity to the changes made by the client can be contained by outputting the data using a printer provided by an image processing service provider other print service provider.

The reference output device can be a printer used by an image processing service provider when providing a client with image processing services. Alternatively, to ensure that the client can get image processing services at a later date, the reference output device can be the printer of the print service provider, which is the same with or different from that of the image processing service provider, for creating a print in response to the photo net service or the like which can be easily used indirectly through an unmanned reception terminal installed at a service window, station or convenience store for easy direct access or a communications network, based on order information and/or client information.

(85) The image data providing method, described in anyone of items 79-83, characterized in that, the first output device is a printer equipped at a site of the client who requests the image-processing service from the image-processing service provider.

According to the present invention described in item 7 or item 85, the reference rendering information is recorded where the printer used by the client is utilized as a reference output device. This allows the client to make a desired change, based on the reference rendering information compatible with his or her printer. The image data updated in this manner is the image data compatible with the print outputted from the client's own printer. When the data is outputted from the client's own printer, a high-quality print is finished in conformity to the intension and preference of the client.

(86) The image data providing method, described in anyone of items 79-85, characterized by further comprising the step of:

setting the first output device designated.

According to the present invention described in item 8 or item 86, the output device used to output these edit images such as the printer of the print service provider, which is the same with or different from that of the image processing service provider and/or the client's own printer is specified to the image processing service provider by the client.

Thus, reference information is recorded when the output device specified to the service provider by the client is used as the reference output device. This allows the client to make a desired change, based on the reference rendering information compatible with the output device specified by him or herself. The image data updated in this manner is the image data compatible with the output device used to output these edit images. Thus, when the image data having been edited is outputted by the printer, a high-quality print is obtained in conformity to the intension and preference of the client.

According to the present invention described in items 84-86, when the printer outputs the prints based on the output-referred image data generated on the basis of the rendering condition established by the user or the image-processing service provider, it is also possible to set the information for acquiring the rendering condition, by which the print having the quality desired by the user can be obtained, as the reference rendering condition.

In this way, the rendering information when the print finished to meet the preference of the client has been obtained is recorded as reference rendering information. This allows the client to change the rendering condition, based on the reference rendering information for ensuring the desired finish, with the result that finer adjustment can be made in conformity to the intension and preference of the client.

(87) The image data providing method, described in anyone of items 79-86, further comprising the step of:

generating the first output-referred image data, based on the first optimizing condition;

characterized in that, in the recording step, the first output-referred image data are recorded while being correlated with the data including the expanded color-range image data and/or the first optimizing condition data.

According to the present invention described in item 9 or item 87, the reference output-referred image data is recorded in the state associated with the data including the expanded color-range image data and/or reference rendering information, so the client or a third party supplied with image data by the client can create a print directly from the reference output-referred image data. Further, the rendering condition conforming to the preference can be set by observing the created print.

(88) The image data providing method, described in item 87, characterized in that,

in the recording step, the first optimizing condition data are recorded as tag information of the first output-referred image data.

According to the present invention described in item 10 or item 88, as described above, the reference rendering information is recorded as the tag information of the above-mentioned reference output-referred image data (meta-data). This reduces the possibility of the association between reference rendering information and reference output-referred image data being lost, and ensures a stable supply of information to the client. This is also effective in recording multiple sets of the reference rendering information and the corresponding reference output-referred image data.

(89) The image data providing method, described in item 87 or item 88, characterized in that,

in the differential image data generating step, second differential image data, which represent a difference between the expanded color-range image data and the first output-referred image data, are generated; and

in the recording step, the second output-referred image data are recorded while being correlated with the first output-referred image data.

According to the present invention described in item 11 or item 89, since the reference output-referred image data having the size smaller than that of the expanded color-range image data and differential image data are recorded, it is possible to supply the client with the reduced amount of expanded color-range image data.

(90) The image data providing method, described in anyone of items 87-89, characterized in that,

in the determining step, a second optimizing condition, being suitable for the second output device, for generating second output-referred image data, based on second device characteristic data in respect to a second output device, which is different from the first output device, and the data including the expanded color-range image data, is determined; and

in the output-referred image data generating step, the second output-referred image data are generated, based on the data including the expanded color-range image data and the second optimizing condition; and

in the recording step, the first output-referred image data are recorded while being correlated with the second output-referred image data.

According to the present invention described in item 12 or item 90, when two or more reference output devices are set, the output-referred image data compatible with the output device different from the reference output device can be reference output-referred image data compatible with any reference output device, or reference output-referred image data compatible with an output device other than reference output device. A display monitor is suitably used as the output device other than reference output device, and sRGB image data or thumbnail image is suitably used as the output-referred image data. It is also possible to share the use of output-referred image data compatible with at least one output device.

The reference output-referred image data is recorded in the state associated with the output-referred image data compatible with the output device different from the reference output device. This allows the client to select the image to be processed, i.e. the data including the expanded color-range image data recorded in an associated state and reference rendering information, for example, by outputting the output-referred image data compatible with the output device different from the reference output device. Further, even if the data including the expanded color-range image data in the environment for each client cannot be used, the data can be outputted to an output device corresponding to the reduced image data so that it can be used.

(91) The image data providing method, described in item 90, characterized in that,

in the differential image data generating step, third differential image data, which represent a difference between the first output-referred image data and the second output-referred image data, are generated; and

in the recording step, the third output-referred image data are recorded while being correlated with the second output-referred image data.

Incidentally, it is also possible to arrange such a configuration that the difference data between the expanded color-range image data and reference output-referred image data and that between the reference output-referred image data and second output-referred image data are recorded as tag information on the header of the second output-referred image data.

According to the present invention described in item 13 or item 91, since the difference data between the reference output-referred image data and second output-referred image data is recorded in a state associated with the second output-referred image data, the client can be supplied with the reference output-referred image data of a reduced size.

(92) The image data providing method, described in anyone of items 79-84 and 86-91, further comprising the step of:

making the first output device to produce a first print by forming an image, represented by the first output-referred image data, on a printing medium;

characterized in that, in the print producing step, the first output device is made to produce the first print by forming the image represented by the first output-referred image data, while correlating the first output-referred image data with the data including the expanded color-range image data and the first optimizing condition.

Incidentally, it is preferred that rendering information be supplied to the client after having been printed on the printing medium associated with the visible image formed on the printing medium.

According to the present invention described in item 14 or item 92, the first print and the data including the expanded color-range image data recorded in the form associated therewith are provided to the client after having been associated with each other. This permits the client to observe the first printer and to set the rendering condition so as to meet his or her preference by making reference to the reference rendering information.

(93) The image data providing method, described in item 92, characterized in that,

in the determining step, a third optimizing condition, which is different from the first optimizing condition in respect to at least one processing condition and/or a processing order, is determined; and

in the output-referred image data generating step, third output-referred image data are generated, based on the data including the expanded color-range image data and the third optimizing condition; and

in the print producing step, the first output device is made to produce the second print by forming the image, represented by the third output-referred image data, on a printing medium.

Incidentally, it is preferred that rendering information be supplied to the client after having been printed on the printing medium associated with the visible image formed on the printing medium.

It is also possible to arrange such a configuration that the rendering information recorded on the printing medium be printed on the printing medium after having been associated with the information representing the differences from the same or different rendering information and the visible image formed on the printing medium. For example, if the rendering information to be printed is the third optimizing condition data (hereinafter referred to as “comparative rendering information”), it is possible to arrange such a configuration that the difference from the reference rendering information is printed out or only the different condition is printed out.

According to the present invention described in item 15 or item 93, based on the rendering condition different from that of the reference rendering information in at least one processing condition and/or sequence of processing, the third output-referred image data (hereinafter referred to as “comparative output-referred image data”) is generated, and the second print is created and supplied to the client. This allows the client to set the rendering condition so as to conform to his or her preference, by observing the second print and making reference to the relationship between the differences in the rendering conditions and/or sequence of processing and print finish characteristics.

(94) The image data providing method, described in item 93, characterized in that,

in the print producing step, the first output device is made to produce the second print by forming the image represented by the difference between the first output-referred image data and the third output-referred image data on the, on the printing medium.

According to the present invention described in item 16 or item 94, since the second print is created based on the difference between the reference output-referred image data and comparative output-referred image data, and is supplied to the client, the relationship between the differences in the rendering conditions and/or sequence of processing and print finish characteristics can be easily identified by the client observing the second print. This permits the client to set the rendering condition by making reference to the reference rendering information and/or comparative rendering information.

(95) The image data providing method, described in item 93 or item 94, characterized in that,

in the print producing step, the first output device is made to produce the second print by forming the first print and the second print, on the same printing medium.

According to the present invention described in item 17 or item 95, the first and second prints are supplied to the client after having been formed on one and the same printing medium, the client. This enables the client to easily identify the relationship between the differences in the rendering conditions and/or sequence of processing and print finish quality, by comparatively observing the corresponding first and second prints. Thus, the client can set the rendering condition so as to meet his or her preference, by making reference to the reference rendering information and/or comparative rendering information.

(96) The image data providing method, described in anyone of items 93-95, characterized in that,

in the print producing step, the first output device is made to produce the second print by forming the image represented by the third output-referred image data, while reducing the image based on a predetermined reduction ratio.

According to the present invention described in item 18 or item 96, since the second printing is carried out in a reduced scale, a greater number of second prints can be created per unit area of the printing medium, multiple second prints of different the rendering conditions and/or the sequences of processing can be formed on one and the same printing medium.

Further, the client can easily identify the relationship between the differences in the rendering conditions and/or the sequences of processing and propensities affecting the printing finish, by comparative observation of the corresponding first and second print. Thus, the client can set the rendering condition so as to meet his or her preference, by making reference to the reference rendering information and/or comparative rendering information.

Further, the present invention is applicable even when differences in the rendering conditions and/or the sequences of processing in the reference rendering information and comparative rendering information appear in the form of finished colors and brightness over a certain range.

(97) The image data providing method, described in anyone of items 93-96, further comprising the step of:

trimming a part of the image represented by the third output-referred image data;

characterized in that, in the print producing step, the first output device is made to produce the second print by forming the third output-referred image data trimmed in the above on the printing medium.

According to the present invention described in item 19 or item 97, since the second print is created by trimming part of the image, the second print will be clearly visible if it is created by printing the trimmed portion enlarged an enlarged scale. When the printing scale is not changed, a greater number of the second prints can be formed per unit area of the printing medium. Accordingly, multiple second prints of different rendering conditions and/or the sequences of processing can be printed on one and the same printing medium.

The client can easily identify the relationship between the differences in the rendering conditions and/or the sequences of processing and the degree of printing finish, by comparative observation of the corresponding first and second print. Thus, the client can set the rendering condition so as to meet his or her preference, by making reference to the reference rendering information and/or comparative rendering information.

The trimming range is preferred to be the position affected by the rendering conditions and/or the sequences of processing of the reference rendering information and comparative rendering information. It is more preferred to be the range including main subject of an image such as a person.

(98) The image data providing method, described in anyone of items 79-97, characterized in that,

in the recording step, the data including the expanded color-range image data and the first optimizing condition data are recorded in a computer-readable storage medium, while correlating them with each other.

According to the present invention described in item 20 or item 98, the data including the expanded color-range image data and the reference rendering information are supplied to the client after having been recorded in the form associated with each other in a portable recording medium that can be read by a computer. This allows the client to perform image processing in the familiar environment such as his or her home.

(99) The image data providing method, described in anyone of items 79-98, characterized in that,

in the recording step, the data including the expanded color-range image data and the first optimizing condition data are recorded in a server coupled to a communication network, while correlating them with each other.

According to the present invention described in item 21 or item 99, the data including the expanded color-range image data and the reference rendering information are supplied to the client through the communications network. This saves the client's time of visiting a shop front or his postal charges, and eliminates the restrictions of time.

(100) The image data providing method, described in anyone of items 79-99, characterized in that,

in the recording step, an optimization processing program, for acquiring the fourth optimizing condition, based on the data including expanded color-range image data and the first optimizing condition data, is recorded in a computer-readable storage medium.

Incidentally, in this case, the program can be run by image processing program or plug-in software as the existing image processing software. Similarly to the general application software, it is preferred to have a function of outputting the processing object to the printer and creating a hardcopy print.

According to the present invention described in item 22 or item 100, by allowing the provided program to be run by a computer, the client can set the rendering condition so as to conform to his or her preference by referring to the reference rendering information.

(101) The image data providing method, described in item 100, characterized in that,

in the recording step, the optimization processing program, for generating and recording the fourth output-referred image data, based on the data including expanded color-range image data and the fourth optimizing condition data, is recorded in the computer-readable storage medium.

According to the present invention described in item 23 or item 101, the client can immediately output the generated image to the printer to create a print finished to meet his or her preference. Further, using the recorded output-referred image data, the client can create a desired print by outputting it to an output device used to output a print at a later date, for example, the printer of the client or the image processing service provider.

Further, in the processing program for rendering according to the present invention (called “rendering processing program”), it is also possible to provide a function of attaching order information to the image data and requesting services of an image processing service provider via the communications network and others, in addition to image viewing function and printing function.

Still further, when the output-referred image data is recorded, it is preferred to record it in the form associated with the other output-referred image data, as described above. In this case, it is also possible to arrange such a configuration that the differential image data from the other output-referred image data is recorded. The other output-referred image data to be recorded in the associated form can be the reference output-referred image data compatible with the reference output device or the output-referred image data compatible with the output device other than the reference output device. It is preferred to be the sRGB image data compatible with the output from a display monitor.

Still further, it is possible to add to this rendering processing program the function of performing the processing of recording a newly set rendering information and output-referred image data in the from associated with each other. It is also possible to record newly set rendering information as tag information of the output-referred image data, similarly to the method of recording the above-mentioned reference rendering information.

(102) The image data providing method, described in item 101, characterized in that,

in the recording step, the optimization processing program, for recording the fourth output-referred image data while correlating the fourth output-referred image data with the data including the expanded color-range image data and/or the first optimizing condition data, is recorded in the computer-readable storage medium.

According to the present invention described in item 24 or item 102, by executing the supplied rendering processing program, the client can set the reference rendering information so as to meet his or her preference by making reference to the reference rendering information.

(103) The image data providing method, described in anyone of items 100-102, characterized in that,

in the recording step, the optimization processing program, for recording the fourth optimizing condition data while correlating the fourth optimizing condition data with the data including the expanded color-range image data and/or the first optimizing condition data, is recorded in the computer-readable storage medium.

According to the present invention described in item 25 or item 103, a client himself or herself and a third party having received data from the client (a client's family member, friend, acquaintance, image processing service provider, etc.) can read a newly set rendering information from a portable recording medium that permits reading by a computer. Based on this rendering information, the client can create output-referred image data and output it to a printer, thereby creating a print finished to meet the client's preference. Alternatively, the client can set a further different rendering condition by making reference to the newly set rendering information.

In this case, it is also possible to arrange such a configuration as to create a separate file for recording newly set rendering information, or to record it as the tag information of the image file for recording in the associated form.

Further, it is also possible to arrange such a configuration that newly set rendering information is the information for representing the differences from other rendering information. For example, it is also possible to record the differences from the reference rendering information or record only different conditions.

Alternatively, it is also possible to record newly set information by replacing it with reference rendering information.

(104) The image data providing method, described in anyone of items 79-103, characterized in that,

in the acquiring step, scene-referred image data, which are standardized from scene-referred raw data, including device characteristics of an image-capturing apparatus, by compensating for the device characteristics, are acquired as the expanded color-range image data; and

in the recording step, the scene-referred image data and the first optimizing condition data are recorded while being correlated with each other.

According to the present invention described in item 26 or item 104, since the reference rendering information and standardized scene-referred image data are recorded, it is possible to generate an image compatible with many types of output devices such as a print device, without the standardized scene-referred image data being generated in the client's environment.

(105) A recording apparatus for recording data for acquiring image data suitable for device characteristics of an output device from an original image, characterized by comprising:

acquiring means for acquiring data including expanded color-range image data from the original image;

determining means for determining a first optimizing condition for generating first output-referred image data from device characteristic data in respect to a first output device and the data including the expanded color-range image data; and

recording means for recording the data including the expanded color-range image data and the first optimizing condition data while correlating them with each other.

The image data recorded in an sRGB standard color space provided by prior-art image processing services is characterized in that the color range and brightness range are compressed so as to conform to the display color range of the display monitor. It has been difficult to make improvements in order to cope with the gradation failure that may occur when mapping onto the color reproduction area of a print device, or several other failures that may occur due to gradation compression conditions during recording. According to the present invention described in item 27 or item 105, by contrast, the expanded color-range image obtained from an original image is recorded, thereby ensuring generation of an image compatible with a great variety of output devices including a print device.

Further, the first optimization processing condition for generating the first output-referred image data is recorded as the first optimization processing condition data in the form associated with expanded color-range image data, and is provided to a client. Thus, by referring to the rendering condition provided as reference rendering information, the client can easily set the desired rendering condition to his or her preference through the step of increasing or decreasing a condition parameter. The output-referred image data, generated by applying processing of rendering to the expanded color-range image data based on the above-mentioned client setting, is outputted onto such an output device as a print device, whereby a high-quality image print desired by the client can be outputted.

(106) The recording apparatus, described in item 105, characterized in that,

the recording means records the first optimizing condition data as tag information of the expanded color-range image data.

According to the present invention described in item 28 or item 106, the reference rendering information is recorded as tag information (meta-data) of the expanded color-range image data so as to reduce the possibility of association between two pieces of information being lost and to ensure a stable supply of information to the client.

(107) The recording apparatus, described in item 105 or item 106, further comprising:

reduced image data generating means for generating reduced image data, being suitable for the output device, from the data including the expanded color-range image data and either the first optimizing condition data or other optimizing condition data, so that a size of the reduced image data becomes smaller than that of the expanded color-range image data;

characterized in that, the recording means records the reduced image data while correlating the reduced image data with the data including the expanded color-range image data and/or the first optimizing condition data.

According to the present invention described in item 29 or item 107, the reduced image data as output-referred image data compatible with the output device is recorded in the form associated with the data including the expanded color-range image data and/or reference rendering information. This makes it possible for the client to select an image as an object of processing, namely the data including the expanded color-range image data recorded by association, and reference rendering information, by outputting reduced image data to an output device or the like. Further, even if the data including the expanded color-range image data cannot be used in the environment for each client, the data can be outputted to an output device corresponding to the reduced image data so that it can be used.

Further, reference rendering information is recorded as the tag information (meta-data) of reduced image data, thereby reducing the possibility of association between two pieces of information being lost and ensuring a stable supply of information to the client.

It is also possible to make such arrangements that the output-referred image data compatible with the output device is the reference output-referred image data compatible with a reference output device, or the output-referred image data compatible with the output device other than reference output device. A display monitor is suitably used as an output device other than reference output device, and the sRGB image data and thumbnail image are suitably used as the output-referred image data.

(108) The recording apparatus, described in item 107, further comprising:

differential image data generating means for generating first differential image data, which represent a difference between the expanded color-range image data and the reduced image data;

characterized in that, the recording means records the first differential image data while correlating the first differential image data with the reduced image data.

According to the present invention described in item 30 or item 108, since the first differential image is recorded in a state associated with the reduced image data of small size, it can be supplied to the client after the amount of the expanded color-range image data has been reduced.

Incidentally, the reduced image data can be reference output-referred image data compatible with a reference output device or output-referred image data compatible with the output device other than the reference output device. It is more preferred if it is an sRGB image data compatible with a display monitor.

(109) The recording apparatus, described in item 107 or item 108, characterized in that,

the recording means records the first differential image data as tag information of the reduced image data.

According to the present invention described in item 31 or item 109, the first differential image data is recorded as the tag information of the reduced image data (meta-data). This feature reduces the possibility of the association between expanded color-range image data and reduced image data, and ensures a stable supply of information to the client.

(110) The recording apparatus, described in anyone of items 105-109, characterized in that,

the first output device is a printer equipped at the image-processing service provider or another print service provider.

According to the present invention described in item 32 or item 110, the reference rendering information is recorded while the printer of an image processing service provider or other print service provider is used as a reference output device. This allows a client to change the image data in conformity to his or her preference, based on the reference rendering information compatible with the printer of an image processing service provider or other print service provider. The updated image data is image data compatible with the print output from a printer provided by an image processing service provider other print service provider. Thus, a high quality print finished in conformity to the changes made by the client can be contained by outputting the data using a printer provided by an image processing service provider other print service provider.

The reference output device can be a printer used by an image processing service provider when providing a client with image processing services. Alternatively, to ensure that the client can get image processing services at a later date, the reference output device can be the printer of the print service provider, which is the same with or different from that of the image processing service provider, for creating a print in response to the photo net service or the like which can be easily used indirectly through an unmanned reception terminal installed at a service window, station or convenience store for easy direct access or a communications network, based on order information and/or client information.

(111) The recording apparatus, described in anyone of items 105-109, characterized in that,

the first output device is a printer equipped at a site of the client who requests the image-processing service from the image-processing service provider.

According to the present invention described in item 33 or item 111, the reference rendering information is recorded where the printer used by the client is utilized as a reference output device. This allows the client to make a desired change, based on the reference rendering information compatible with his or her printer. The image data updated in this manner is the image data compatible with the print outputted from the client's own printer. When the data is outputted from the client's own printer, a high-quality print is finished in conformity to the intension and preference of the client.

(112) The recording apparatus, described in anyone of items 105-111, characterized by further comprising:

setting means for setting the first output device designated.

According to the present invention described in item 34 or item 112, the output device used to output these edit images such as the printer of the print service provider, which is the same with or different from that of the image processing service provider and/or the client's own printer is specified to the image processing service provider by the client.

Thus, reference information is recorded when the output device specified to the service provider by the client is used as the reference output device. This allows the client to make a desired change, based on the reference rendering information compatible with the output device specified by him or herself. The image data updated in this manner is the image data compatible with the output device used to output these edit images. Thus, when the image data having been edited is outputted by the printer, a high-quality print is obtained in conformity to the intension and preference of the client.

According to the present invention described in items 110-112, when the printer outputs the prints based on the output-referred image data generated on the basis of the rendering condition established by the user or the image-processing service provider, it is also possible to set the information for acquiring the rendering condition, by which the print having the quality desired by the user can be obtained, as the reference rendering condition.

In this way, the rendering information when the print finished to meet the preference of the client has been obtained is recorded as reference rendering information. This allows the client to change the rendering condition, based on the reference rendering information for ensuring the desired finish, with the result that finer adjustment can be made in conformity to the intension and preference of the client.

(113) The recording apparatus, described in anyone of items 105-112, further comprising:

output-referred image data generating means for generating the first output-referred image data, based on the first optimizing condition;

characterized in that the recording means records the first output-referred image data while correlatinged the first output-referred image data with the data including the expanded color-range image data and/or the first optimizing condition data.

According to the present invention described in item 35 or item 113, the reference output-referred image data is recorded in the state associated with the data including the expanded color-range image data and/or reference rendering information, so the client or a third party supplied with image data by the client can create a print directly from the reference output-referred image data. Further, the rendering condition conforming to the preference can be set by observing the created print.

(114) The recording apparatus, described in item 113, characterized in that,

the recording means records the first optimizing condition data as tag information of the first output-referred image data.

According to the present invention described in item 36 or item 114, as described above, the reference rendering information is recorded as the tag information of the above-mentioned reference output-referred image data (meta-data). This reduces the possibility of the association between reference rendering information and reference output-referred image data being lost, and ensures a stable supply of information to the client. This is also effective in recording multiple sets of the reference rendering information and the corresponding reference output-referred image data.

(115) The recording apparatus, described in item 112 or item 113, characterized in that,

the differential image data generating means generates second differential image data, which represent a difference between the expanded color-range image data and the first output-referred image data; and

the recording means records the second output-referred image data while correlating the second output-referred image data with the first output-referred image data.

According to the present invention described in item 37 or item 114, since the reference output-referred image data having the size smaller than that of the expanded color-range image data and differential image data are recorded, it is possible to supply the client with the reduced amount of expanded color-range image data.

(116) The recording apparatus, described in anyone of items 113-115, characterized in that,

the determining means determines a second optimizing condition, being suitable for the second output device, for generating second output-referred image data, based on second device characteristic data in respect to a second output device, which is different from the first output device, and the data including the expanded color-range image data; and

the output-referred image data generating means generats the second output-referred image data, based on the data including the expanded color-range image data and the second optimizing condition; and

the recording means records the first output-referred image data while correlating the first output-referred image data with the second output-referred image data.

According to the present invention described in item 38 or item 116, when two or more reference output devices are set, the output-referred image data compatible with the output device different from the reference output device can be reference output-referred image data compatible with any reference output device, or reference output-referred image data compatible with an output device other than reference output device. A display monitor is suitably used as the output device other than reference output device, and sRGB image data or thumbnail image is suitably used as the output-referred image data. It is also possible to share the use of output-referred image data compatible with at least one output device.

The reference output-referred image data is recorded in the state associated with the output-referred image data compatible with the output device different from the reference output device. This allows the client to select the image to be processed, i.e. the data including the expanded color-range image data recorded in an associated state and reference rendering information, for example, by outputting the output-referred image data compatible with the output device different from the reference output device. Further, even if the data including the expanded color-range image data in the environment for each client cannot be used, the data can be outputted to an output device corresponding to the reduced image data so that it can be used.

(117) The recording apparatus, described in item 116, characterized in that,

the differential image data generating means generats third differential image data, which represent a difference between the first output-referred image data and the second output-referred image data; and

the recording means records the third output-referred image data while correlating the third output-referred image data with the second output-referred image data.

Incidentally, it is also possible to arrange such a configuration that the difference data between the expanded color-range image data and reference output-referred image data and that between the reference output-referred image data and second output-referred image data are recorded as tag information on the header of the second output-referred image data.

According to the present invention described in item 39 or item 117, since the difference data between the reference output-referred image data and second output-referred image data is recorded in a state associated with the second output-referred image data, the client can be supplied with the reference output-referred image data of a reduced size.

(118) The recording apparatus, described in anyone of items 105-110 and 112-117, further comprising:

print producing means for making the first output device to produce a first print by forming an image, represented by the first output-referred image data, on a printing medium;

characterized in that, the print producing means makes the first output device to produce the first print by forming the image represented by the first output-referred image data, while correlating the first output-referred image data with the data including the expanded color-range image data and the first optimizing condition.

Incidentally, it is preferred that rendering information be supplied to the client after having been printed on the printing medium associated with the visible image formed on the printing medium.

According to the present invention described in item 40 or item 118, the first print and the data including the expanded color-range image data recorded in the form associated therewith are provided to the client after having been associated with each other. This permits the client to observe the first printer and to set the rendering condition so as to meet his or her preference by making reference to the reference rendering information.

(119) The recording apparatus, described in item 118, characterized in that,

the determining means determins a third optimizing condition, which is different from the first optimizing condition in respect to at least one processing condition and/or a processing order; and

the output-referred image data generating means generats third output-referred image data, based on the data including the expanded color-range image data and the third optimizing condition; and

the print producing means makes the first output device to produce the second print by forming the image, represented by the third output-referred image data, on a printing medium.

Incidentally, it is preferred that rendering information be supplied to the client after having been printed on the printing medium associated with the visible image formed on the printing medium.

It is also possible to arrange such a configuration that the rendering information recorded on the printing medium be printed on the printing medium after having been associated with the information representing the differences from the same or different rendering information and the visible image formed on the printing medium. For example, if the rendering-information to be printed is the comparative rendering information, it is possible to arrange such a configuration that the difference from the reference rendering information is printed out or only the different condition is printed out.

According to the present invention described in item 41 or item 119, based on the rendering condition different from that of the reference rendering information in at least one processing condition and/or sequence of processing, the comparative output-referred image data is generated, and the second print is created and supplied to the client. This allows the client to set the rendering condition so as to conform to his or her preference, by observing the second print and making reference to the relationship between the differences in the rendering conditions and/or sequence of processing and print finish characteristics.

(120) The recording apparatus, described in item 119, characterized in that,

the print producing means makes the first output device to produce the second print by forming the image represented by the difference between the first output-referred image data and the third output-referred image data, on the printing medium.

According to the present invention described in item 42 or item 120, since the second print is created based on the difference between the reference output-referred image data and comparative output-referred image data, and is supplied to the client, the relationship between the differences in the rendering conditions and/or sequence of processing and print finish characteristics can be easily identified by the client observing the second print. This permits the client to set the rendering condition by making reference to the reference rendering information and/or comparative rendering information.

(121) The recording apparatus, described in item 119 or item 120, characterized in that,

the print producing means makes the first output device to produce the second print by forming the first print and the second print, on the same printing medium.

According to the present invention described in item 43 or item 121, the first and second prints are supplied to the client after having been formed on one and the same printing medium, the client. This enables the client to easily identify the relationship between the differences in the rendering conditions and/or sequence of processing and print finish quality, by comparatively observing the corresponding first and second prints. Thus, the client can set the rendering condition so as to meet his or her preference, by making reference to the reference rendering information and/or comparative rendering information.

(122) The recording apparatus, described in anyone of items 119-121, characterized in that,

the print producing step, the first output device is made to produce the second print by forming the image represented by the third output-referred image data, while reducing the image based on a predetermined reduction ratio.

According to the present invention described in item 44 or item 122, since the second printing is carried out in a reduced scale, a greater number of second prints can be created per unit area of the printing medium, multiple second prints of different the rendering conditions and/or the sequences of processing can be formed on one and the same printing medium.

Further, the client can easily identify the relationship between the differences in the rendering conditions and/or the sequences of processing and propensities affecting the printing finish, by comparative observation of the corresponding first and second print. Thus, the client can set the rendering condition so as to meet his or her preference, by making reference to the reference rendering information and/or comparative rendering information.

Further, the present invention is applicable even when differences in the rendering conditions and/or the sequences of processing in the reference rendering information and comparative rendering information appear in the form of finished colors and brightness over a certain range.

(123) The recording apparatus, described in anyone of items 119-122, further comprising:

trimming means for trimming a part of the image represented by the third output-referred image data;

characterized in that the print producing means makes the first output device to produce the second print by forming the third output-referred image data trimmed in the above on the printing medium.

According to the present invention described in item 45 or item 123, since the second print is created by trimming part of the image, the second print will be clearly visible if it is created by printing the trimmed portion enlarged an enlarged scale. When the printing scale is not changed, a greater number of the second prints can be formed per unit area of the printing medium. Accordingly, multiple second prints of different rendering conditions and/or the sequences of processing can be printed on one and the same printing medium.

The client can easily identify the relationship between the differences in the rendering conditions and/or the sequences of processing and the degree of printing finish, by comparative observation of the corresponding first and second print. Thus, the client can set the rendering condition so as to meet his or her preference, by making reference to the reference rendering information and/or comparative rendering information.

The trimming range is preferred to be the position affected by the rendering conditions and/or the sequences of processing of the reference rendering information and comparative rendering information. It is more preferred to be the range including main subject of an image such as a person.

(124) The recording apparatus, described in anyone of items 105-123, characterized in that,

the recording means records the data including the expanded color-range image data and the first optimizing condition data in a computer-readable storage medium, while correlating them with each other.

According to the present invention described in item 46 or item 124, the data including the expanded color-range image data and the reference rendering information are supplied to the client after having been recorded in the form associated with each other in a portable recording medium that can be read by a computer. This allows the client to perform image processing in the familiar environment such as his or her home.

(125) The recording apparatus, described in anyone of items 105-124, characterized in that,

the recording means records the data including the expanded color-range image data and the first optimizing condition data in a server coupled to a communication network, while correlating them with each other.

According to the present invention described in item 47 or item 125, the data including the expanded color-range image data and the reference rendering information are supplied to the client through the communications network. This saves the client's time of visiting a shop front or his postal charges, and eliminates the restrictions of time.

(126) The recording apparatus, described in anyone of items 105-125, characterized in that,

the recording means records an optimization processing program, for acquiring the fourth optimizing condition, based on the data including expanded color-range image data and the first optimizing condition data, in a computer-readable storage medium.

Incidentally, in this case, the program can be run by image processing program or plug-in software as the existing image processing software. Similarly to the general application software, it is preferred to have a function of outputting the processing object to the printer and creating a hardcopy print.

According to the present invention described in item 48 or item 126, by allowing the provided program to be run by a computer, the client can set the rendering condition so as to conform to his or her preference by referring to the reference rendering information.

(127) The recording apparatus, described in item 126, characterized in that,

the recording means records the optimization processing program, for generating and recording the fourth output-referred image data, based on the data including expanded color-range image data and the fourth optimizing condition data, in the computer-readable storage medium.

According to the present invention described in item 49 or item 127, the client can immediately output the generated image to the printer to create a print finished to meet his or her preference. Further, using the recorded output-referred image data, the client can create a desired print by outputting it to an output device used to output a print at a later date, for example, the printer of the client or the image processing service provider.

Further, in the processing program for rendering according to the present invention (called “rendering processing program”), it is also possible to provide a function of attaching order information to the image data and requesting services of an image processing service provider via the communications network and others, in addition to image viewing function and printing function.

Still further, when the output-referred image data is recorded, it is preferred to record it in the form associated with the other output-referred image data, as described above. In this case, it is also possible to arrange such a configuration that the differential image data from the other output-referred image data is recorded. The other output-referred image data to be recorded in the associated form can be the reference output-referred image data compatible with the reference output device or the output-referred image data compatible with the output device other than the reference output device. It is preferred to be the sRGB image data compatible with the output from a display monitor.

Still further, it is possible to add to this rendering processing program the function of performing the processing of recording a newly set rendering information and output-referred image data in the from associated with each other. It is also possible to record newly set rendering information as tag information of the output-referred image data, similarly to the method of recording the above-mentioned reference rendering information.

(128) The recording apparatus, described in item 127, characterized in that,

the recording means records the optimization processing program, for recording the fourth output-referred image data while correlating the fourth output-referred image data with the data including the expanded color-range image data and/or the first optimizing condition data, in the computer-readable storage medium.

According to the present invention described in item 50 or item 128, by executing the supplied rendering processing program, the client can set the reference rendering information so as to meet his or her preference by making reference to the reference rendering information.

(129) The recording apparatus, described in anyone of items 126-128, characterized in that,

the recording means records the optimization processing program, for recording the fourth optimizing condition data while correlating the fourth optimizing condition data with the data including the expanded color-range image data and/or the first optimizing condition data, in the computer-readable storage medium.

According to the present invention described in item 51 or item 129, a client himself or herself and a third party having received data from the client (a client's family member, friend, acquaintance, image processing service provider, etc.) can read a newly set rendering information from a portable recording medium that permits reading by a computer. Based on this rendering information, the client can create output-referred image data and output it to a printer, thereby creating a print finished to meet the client's preference. Alternatively, the client can set a further different rendering condition by making reference to the newly set rendering information.

In this case, it is also possible to arrange such a configuration as to create a separate file for recording newly set rendering information, or to record it as the tag information of the image file for recording in the associated form.

Further, it is also possible to arrange such a configuration that newly set rendering information is the information for representing the differences from other rendering information. For example, it is also possible to record the differences from the reference rendering information or record only different conditions.

Alternatively, it is also possible to record newly set information by replacing it with reference rendering information.

(130) The recording apparatus, described in anyone of items 105-129, characterized in that,

the acquiring means acquires scene-referred image data, which are standardized from scene-referred raw data, including device characteristics of an image-capturing apparatus, by compensating for the device characteristics, as the expanded color-range image data; and

the recording means records the scene-referred image data and the first optimizing condition data while correlating them with each other.

According to the present invention described in item 52 or item 130, since the reference rendering information and standardized scene-referred image data are recorded, it is possible to generate an image compatible with many types of output devices such as a print device, without the standardized scene-referred image data being generated in the client's environment.

(131) A program for a computer that controls a recording apparatus, which acquire image data suitable for characteristics of an output device, from an original image, the program realizes the functions of:

an acquiring function for acquiring data including expanded color-range image data from the original image;

a determining function for determining a first optimizing condition for generating first output-referred image data from device characteristic data in respect to a first output device and the data including the expanded color-range image data; and

a recording function for recording the data including the expanded color-range image data and the first optimizing condition data while correlating them with each other.

The image data recorded in an sRGB standard color space provided by prior-art image processing services is characterized in that the color range and brightness range are compressed so as to conform to the display color range of the display monitor. It has been difficult to make improvements in order to cope with the gradation failure that may occur when mapping onto the color reproduction area of a print device, or several other failures that may occur due to gradation compression conditions during recording. According to the present invention described in item 53 or item 131, by contrast, the expanded color-range image obtained from an original image is recorded, thereby ensuring generation of an image compatible with a great variety of output devices including a print device.

Further, the first optimization processing condition for generating the first output-referred image data is recorded as the first optimization processing condition data in the form associated with expanded color-range image data, and is provided to a client. Thus, by referring to the rendering condition provided as reference rendering information, the client can easily set the desired rendering condition to his or her preference through the step of increasing or decreasing a condition parameter. The output-referred image data, generated by applying processing of rendering to the expanded color-range image data based on the above-mentioned client setting, is outputted onto such an output device as a print device, whereby a high-quality image print desired by the client can be outputted.

(132) The program, described in item 131, characterized in that,

the recording function includes a function for recording the first optimizing condition data as tag information of the expanded color-range image data.

According to the present invention described in item 54 or item 132, the reference rendering information is recorded as tag information (meta-data) of the expanded color-range image data so as to reduce the possibility of association between two pieces of information being lost and to ensure a stable supply of information to the client.

(133) The program, described in item 131 or item 132, further realizing the function of:

a generating function for generating reduced image data, being suitable for the output device, from the data including the expanded color-range image data and either the first optimizing condition data or other optimizing condition data, so that a size of the reduced image data becomes smaller than that of the expanded color-range image data;

characterized in that the recording function includes a function for recording the reduced image data while correlating the reduced image data with the data including the expanded color-range image data and/or the first optimizing condition data.

According to the present invention described in item 55 or item 133, the reduced image data as output-referred image data compatible with the output device is recorded in the form associated with the data including the expanded color-range image data and/or reference rendering information. This makes it possible for the client to select an image as an object of processing, namely the data including the expanded color-range image data recorded by association, and reference rendering information, by outputting reduced image data to an output device or the like. Further, even if the data including the expanded color-range image data cannot be used in the environment for each client, the data can be outputted to an output device corresponding to the reduced image data so that it can be used.

Further, reference rendering information is recorded as the tag information (meta-data) of reduced image data, thereby reducing the possibility of association between two pieces of information being lost and ensuring a stable supply of information to the client.

It is also possible to make such arrangements that the output-referred image data compatible with the output device is the reference output-referred image data compatible with a reference output device, or the output-referred image data compatible with the output device other than reference output device. A display monitor is suitably used as an output device other than reference output device, and the sRGB image data and thumbnail image are suitably used as the output-referred image data.

(134) The program, described in item 133, further realizing the function of:

a differential image data generating function for generating first differential image data, which represent a difference between the expanded color-range image data and the reduced image data;

characterized in that the recording function includes a function for recording the first differential image data while correlating the first differential image data with the reduced image data.

According to the present invention described in item 56 or item 134, since the first differential image is recorded in a state associated with the reduced image data of small size, it can be supplied to the client after the amount of the expanded color-range image data has been reduced.

The reduced image data can be reference output-referred image data compatible with a reference output device or output-referred image data compatible with the output device other than the reference output device. It is more preferred if it is an sRGB image data compatible with a display monitor.

(135) The program, described in item 133 or item 134, characterized in that,

the recording function includes a function for recording the first differential image data as tag information of the reduced image data.

According to the present invention described in item 57 or item 135, the first differential image data is recorded as the tag information of the reduced image data (meta-data). This feature reduces the possibility of the association between expanded color-range image data and reduced image data, and ensures a stable supply of information to the client.

(136) The program, described in anyone of items 131-135, characterized in that,

the first output device is a printer equipped at the image-processing service provider or another print service provider.

According to the present invention described in item 58 or item 136, the reference rendering information is recorded while the printer of an image processing service provider or other print service provider is used as a reference output device. This allows a client to change the image data in conformity to his or her preference, based on the reference rendering information compatible with the printer of an image processing service provider or other print service provider. The updated image data is image data compatible with the print output from a printer provided by an image processing service provider other print service provider. Thus, a high quality print finished in conformity to the changes made by the client can be contained by outputting the data using a printer provided by an image processing service provider other print service provider.

The reference output device can be a printer used by an image processing service provider when providing a client with image processing services. Alternatively, to ensure that the client can get image processing services at a later date, the reference output device can be the printer of the print service provider, which is the same with or different from that of the image processing service provider, for creating a print in response to the photo net service or the like which can be easily used indirectly through an unmanned reception terminal installed at a service window, station or convenience store for easy direct access or a communications network, based on order information and/or client information.

(137) The program, described in anyone of items 131-135, characterized in that,

the first output device is a printer equipped at a site of the client who requests the image-processing service from the image-processing service provider.

According to the present invention described in item 59 or item 137, the reference rendering information is recorded where the printer used by the client is utilized as a reference output device. This allows the client to make a desired change, based on the reference rendering information compatible with his or her printer. The image data updated in this manner is the image data compatible with the print outputted from the client's own printer. When the data is outputted from the client's own printer, a high-quality print is finished in conformity to the intension and preference of the client.

(138) The program, described in anyone of items 131-137, characterized by further realizing the function of:

a setting function for setting the first output device designated.

According to the present invention described in item 60 or item 138, the output device used to output these edit images such as the printer of the print service provider, which is the same with or different from that of the image processing service provider and/or the client's own printer is specified to the image processing service provider by the client.

Thus, reference information is recorded when the output device specified to the service provider by the client is used as the reference output device. This allows the client to make a desired change, based on the reference rendering information compatible with the output device specified by him or herself. The image data updated in this manner is the image data compatible with the output device used to output these edit images. Thus, when the image data having been edited is outputted by the printer, a high-quality print is obtained in conformity to the intension and preference of the client.

According to the present invention described in items 136-138, when the printer outputs the prints based on the output-referred image data generated on the basis of the rendering condition established by the user or the image-processing service provider, it is also possible to set the information for acquiring the rendering condition, by which the print having the quality desired by the user can be obtained, as the reference rendering condition.

In this way, the rendering information when the print finished to meet the preference of the client has been obtained is recorded as reference rendering information. This allows the client to change the rendering condition, based on the reference rendering information for ensuring the desired finish, with the result that finer adjustment can be made in conformity to the intension and preference of the client.

(139) The program, described in anyone of items 131-138, characterized by further realizing the function of:

a generating function for generating the first output-referred image data, based on the first optimizing condition;

characterized in that, the recording function includes a function for recording the first output-referred image data while correlating the first output-referred image data with the data including the expanded color-range image data and/or the first optimizing condition data.

According to the present invention described in item 61 or item 139, the reference output-referred image data is recorded in the state associated with the data including the expanded color-range image data and/or reference rendering information, so the client or a third party supplied with image data by the client can create a print directly from the reference output-referred image data. Further, the rendering condition conforming to the preference can be set by observing the created print.

(140) The program, described in item 139, characterized in that,

the recording function includes a function for recording the first optimizing condition data as tag information of the first output-referred image data.

According to the present invention described in item 62 or item 140, as described above, the reference rendering information is recorded as the tag information of the above-mentioned reference output-referred image data (meta-data). This reduces the possibility of the association between reference rendering information and reference output-referred image data being lost, and ensures a stable supply of information to the client. This is also effective in recording multiple sets of the reference rendering information and the corresponding reference output-referred image data.

(141) The program, described in item 139 or item 140, characterized in that,

the the differential image data generating function includes a function for generating second differential image data, which represent a difference between the expanded color-range image data and the first output-referred image data; and

the recording function includes a function for recording the second output-referred image data while correlating the second output-referred image data with the first output-referred image data.

According to the present invention described in item 63 or item 141, since the reference output-referred image data having the size smaller than that of the expanded color-range image data and differential image data are recorded, it is possible to supply the client with the reduced amount of expanded color-range image data.

(142) The program, described in anyone of items 139-141, characterized in that,

the determining function includes a function for determining a second optimizing condition, being suitable for the second output device, for generating second output-referred image data, based on second device characteristic data in respect to a second output device, which is different from the first output device, and the data including the expanded color-range image data; and

the output-referred image data generating function includes a function for generating the second output-referred image data, based on the data including the expanded color-range image data and the second optimizing condition; and

the recording function includes a function for recording the first output-referred image data while correlating the first output-referred image data with the second output-referred image data.

According to the present invention described in item 64 or item 142, when two or more reference output devices are set, the output-referred image data compatible with the output device different from the reference output device can be reference output-referred image data compatible with any reference output device, or reference output-referred image data compatible with an output device other than reference output device. A display monitor is suitably used as the output device other than reference output device, and sRGB image data or thumbnail image is suitably used as the output-referred image data. It is also possible to share the use of output-referred image data compatible with at least one output device.

The reference output-referred image data is recorded in the state associated with the output-referred image data compatible with the output device different from the reference output device. This allows the client to select the image to be processed, i.e. the data including the expanded color-range image data recorded in an associated state and reference rendering information, for example, by outputting the output-referred image data compatible with the output device different from the reference output device. Further, even if the data including the expanded color-range image data in the environment for each client cannot be used, the data can be outputted to an output device corresponding to the reduced image data so that it can be used.

(143) The program, described in item 142, characterized in that,

the differential image data generating function includes a function for generating third differential image data, which represent a difference between the first output-referred image data and the second output-referred image data; and

the recording function includes a function for recording the third differential image data while correlating the third differential image data with the second output-referred image data.

Incidentally, it is also possible to arrange such a configuration that the difference data between the expanded color-range image data and reference output-referred image data and that between the reference output-referred image data and second output-referred image data are recorded as tag information on the header of the second output-referred image data.

According to the present invention described in item 65 or item 143, since the difference data between the reference output-referred image data and second output-referred image data is recorded in a state associated with the second output-referred image data, the client can be supplied with the reference output-referred image data of a reduced size.

(144) The program, described in anyone of items 131-136 and 138-143, further comprising the step of:

making the first output device to produce a first print by forming an image, represented by the first output-referred image data, on a printing medium;

characterized in that, in the print producing step, the first output device is made to produce the first print by forming the image represented by the first output-referred image data, while correlating the first output-referred image data with the data including the expanded color-range image data and the first optimizing condition.

Incidentally, it is preferred that rendering information be supplied to the client after having been printed on the printing medium associated with the visible image formed on the printing medium.

According to the present invention described in item 66 or item 144, the first print and the data including the expanded color-range image data recorded in the form associated therewith are provided to the client after having been associated with each other. This permits the client to observe the first printer and to set the rendering condition so as to meet his or her preference by making reference to the reference rendering information.

(145) The program, described in item 144, characterized in that,

the determining function includes a function for determining a third optimizing condition, which is different from the first optimizing condition in respect to at least one processing condition and/or a processing order; and

the output-referred image data generating function includes a function for generating third output-referred image data, based on the data including the expanded color-range image data and the third optimizing condition; and

the print producing function includes a function for making the first output device to produce the second print by forming the image, represented by the third output-referred image data, on a printing medium.

Incidentally, it is preferred that rendering information be supplied to the client after having been printed on the printing medium associated with the visible image formed on the printing medium.

It is also possible to arrange such a configuration that the rendering information recorded on the printing medium be printed on the printing medium after having been associated with the information representing the differences from the same or different rendering information and the visible image formed on the printing medium. For example, if the rendering information to be printed is the third optimizing condition data (hereinafter referred to as “comparative rendering information”), it is possible to arrange such a configuration that the difference from the reference rendering information is printed out or only the different condition is printed out.

According to the present invention described in item 67 or item 145, based on the rendering condition different from that of the reference rendering information in at least one processing condition and/or sequence of processing, the third output-referred image data (hereinafter referred to as “comparative output-referred image data”) is generated, and the second print is created and supplied to the client. This allows the client to set the rendering condition so as to conform to his or her preference, by observing the second print and making reference to the relationship between the differences in the rendering conditions and/or sequence of processing and print finish characteristics.

(146) The program, described in item 145, characterized in that,

the print producing function includes a function for making the first output device to produce the second print by forming the image represented by the difference between the first output-referred image data and the third output-referred image data on the, on the printing medium.

According to the present invention described in item 68 or item 146, since the second print is created based on the difference between the reference output-referred image data and comparative output-referred image data, and is supplied to the client, the relationship between the differences in the rendering conditions and/or sequence of processing and print finish characteristics can be easily identified by the client observing the second print. This permits the client to set the rendering condition by making reference to the reference rendering information and/or comparative rendering information.

(147) The program, described in item 93 or item 94, characterized in that,

the print producing function includes a function for making the first output device to produce the second print by forming the first print and the second print, on the same printing medium.

According to the present invention described in item 69 or item 147, the first and second prints are supplied to the client after having been formed on one and the same printing medium, the client. This enables the client to easily identify the relationship between the differences in the rendering conditions and/or sequence of processing and print finish quality, by comparatively observing the corresponding first and second prints. Thus, the client can set the rendering condition so as to meet his or her preference, by making reference to the reference rendering information and/or comparative rendering information.

(148) The program, described in anyone of items 145-147, characterized in that,

the print producing function includes a function for making the first output device to produce the second print by forming the image represented by the third output-referred image data, while reducing the image based on a predetermined reduction ratio.

According to the present invention described in item 70 or item 148, since the second printing is carried out in a reduced scale, a greater number of second prints can be created per unit area of the printing medium, multiple second prints of different the rendering conditions and/or the sequences of processing can be formed on one and the same printing medium.

Further, the client can easily identify the relationship between the differences in the rendering conditions and/or the sequences of processing and propensities affecting the printing finish, by comparative observation of the corresponding first and second print. Thus, the client can set the rendering condition so as to meet his or her preference, by making reference to the reference rendering information and/or comparative rendering information.

Further, the present invention is applicable even when differences in the rendering conditions and/or the sequences of processing in the reference rendering information and comparative rendering information appear in the form of finished colors and brightness over a certain range.

(149) The program, described in anyone of items 145-148, further realizing the function of:

a trimming function for trimming a part of the image represented by the third output-referred image data;

characterized in that, the print producing function includes a function for making the first output device to produce the second print by forming the third output-referred image data trimmed in the above on the printing medium.

According to the present invention described in item 71 or item 149, since the second print is created by trimming part of the image, the second print will be clearly visible if it is created by printing the trimmed portion enlarged an enlarged scale. When the printing scale is not changed, a greater number of the second prints can be formed per unit area of the printing medium. Accordingly, multiple second prints of different rendering conditions and/or the sequences of processing can be printed on one and the same printing medium.

The client can easily identify the relationship between the differences in the rendering conditions and/or the sequences of processing and the degree of printing finish, by comparative observation of the corresponding first and second print. Thus, the client can set the rendering condition so as to meet his or her preference, by making reference to the reference rendering information and/or comparative rendering information.

The trimming range is preferred to be the position affected by the rendering conditions and/or the sequences of processing of the reference rendering information and comparative rendering information. It is more preferred to be the range including main subject of an image such as a person.

(150) The program, described in anyone of items 131-149, characterized in that,

the recording function includes a function for recording the data including the expanded color-range image data and the first optimizing condition data in a computer-readable storage medium, while correlating them with each other.

According to the present invention described in item 72 or item 150, the data including the expanded color-range image data and the reference rendering information are supplied to the client after having been recorded in the form associated with each other in a portable recording medium that can be read by a computer. This allows the client to perform image processing in the familiar environment such as his or her home.

(151) The program, described in anyone of items 131-150, characterized in that,

the recording function includes a function for recording the data including the expanded color-range image data and the first optimizing condition data in a server coupled to a communication network, while correlating them with each other.

According to the present invention described in item 73 or item 151, the data including the expanded color-range image data and the reference rendering information are supplied to the client through the communications network. This saves the client's time of visiting a shop front or his postal charges, and eliminates the restrictions of time.

(152) The program, described in anyone of items 131-150, characterized in that,

the recording function includes a function for recording an optimization processing program, for acquiring the fourth optimizing condition, based on the data including expanded color-range image data and the first optimizing condition data, in a computer-readable storage medium.

Incidentally, in this case, the program can be run by image processing program or plug-in software as the existing image processing software. Similarly to the general application software, it is preferred to have a function of outputting the processing object to the printer and creating a hardcopy print.

According to the present invention described in item 74 or item 152, by allowing the provided program to be run by a computer, the client can set the rendering condition so as to conform to his or her preference by referring to the reference rendering information.

(153) The program, described in item 152, characterized in that,

the recording function includes a function for recording the optimization processing program, for generating and recording the fourth output-referred image data, based on the data including expanded color-range image data and the fourth optimizing condition data, in the computer-readable storage medium.

According to the present invention described in item 75 or item 153, the client can immediately output the generated image to the printer to create a print finished to meet his or her preference. Further, using the recorded output-referred image data, the client can create a desired print by outputting it to an output device used to output a print at a later date, for example, the printer of the client or the image processing service provider.

Further, in the processing program for rendering according to the present invention (called “rendering processing program”), it is also possible to provide a function of attaching order information to the image data and requesting services of an image processing service provider via the communications network and others, in addition to image viewing function and printing function.

Still further, when the output-referred image data is recorded, it is preferred to record it in the form associated with the other output-referred image data, as described above. In this case, it is also possible to arrange such a configuration that the differential image data from the other output-referred image data is recorded. The other output-referred image data to be recorded in the associated form can be the reference output-referred image data compatible with the reference output device or the output-referred image data compatible with the output device other than the reference output device. It is preferred to be the sRGB image data compatible with the output from a display monitor.

Still further, it is possible to add to this rendering processing program the function of performing the processing of recording a newly set rendering information and output-referred image data in the from associated with each other. It is also possible to record newly set rendering information as tag information of the output-referred image data, similarly to the method of recording the above-mentioned reference rendering information.

(154) The program, described in item 153, characterized in that,

the recording function includes a function for recording the optimization processing program, for recording the fourth output-referred image data while correlating the fourth output-referred image data with the data including the expanded color-range image data and/or the first optimizing condition data, in the computer-readable storage medium.

According to the present invention described in item 76 or item 154, by executing the supplied rendering processing program, the client can set the reference rendering information so as to meet his or her preference by making reference to the reference rendering information.

(155) The program, described in anyone of items 152-154, characterized in that,

the recording function includes a function for recording the optimization processing program for recording the fourth optimizing condition data, while correlating the fourth optimizing condition data with the data including the expanded color-range image data and/or the first optimizing condition data, in the computer-readable storage medium.

According to the present invention described in item 77 or item 155, a client himself or herself and a third party having received data from the client (a client's family member, friend, acquaintance, image processing service provider, etc.) can read a newly set rendering information from a portable recording medium that permits reading by a computer. Based on this rendering information, the client can create output-referred image data and output it to a printer, thereby creating a print finished to meet the client's preference. Alternatively, the client can set a further different rendering condition by making reference to the newly set rendering information.

In this case, it is also possible to arrange such a configuration as to create a separate file for recording newly set rendering information, or to record it as the tag information of the image file for recording in the associated form.

Further, it is also possible to arrange such a configuration that newly set rendering information is the information for representing the differences from other rendering information. For example, it is also possible to record the differences from the reference rendering information or record only different conditions.

Alternatively, it is also possible to record newly set information by replacing it with reference rendering information.

(156) The program, described in anyone of items 79-103, characterized in that,

in the acquiring step, scene-referred image data, which are standardized from scene-referred raw data, including device characteristics of an image-capturing apparatus, by compensating for the device characteristics, are acquired as the expanded color-range image data; and

in the recording step, the scene-referred image data and the first optimizing condition data are recorded while being correlated with each other.

According to the present invention described in item 78 or item 156, since the reference rendering information and standardized scene-referred image data are recorded, it is possible to generate an image compatible with many types of output devices such as a print device, without the standardized scene-referred image data being generated in the client's environment.

The “original image” is defined as the image handed down from a client or sent to a service provider by mail or communications means, or the image obtained by the image processing service provider photographing the client, when the image processing service is provided to the client in the image processing service based on the method of providing image data according to the present invention. It means an image that can be an object of image processing service. This image is an image having a color range wider than or different from that of the output device. Preferably, it should be an image having a color range wider than that of the output device.

For example, this is the image or CG content obtained by photographing by the client or image processing service provider using a camera, and preferably an image gained by photographing by the client using a photographic film and digital camera.

The “output device” is defined as a printing device for creating an hardcopy image in a display device including a CRT, liquid crystal display and plasma display, and an output medium including silver halide photographic paper and inkjet printer and thermal printer paper.

The “output-referred image data” is defined as digital image data used for image output from the above-mentioned output device. Rendering (to be described later) is provided to get a proper image in the output device for display such as a CRT, liquid crystal display and plasma display, and the output medium including silver halide photographic paper and inkjet printer and thermal printer paper.

“Optimization processing” signifies the processing carried out to get a proper image in the output device for display such as a CRT, liquid crystal display and plasma display, and the output medium including silver halide photographic paper and inkjet printer and thermal printer paper. Rendering is defined as the processing carries out to ensure proper color reproduction within the color range conforming to the sRGB standard, for example, on the basis of display on the CRT display monitor conforming to the sRGB standard. On the basis of outputting onto silver halide photographic paper, rendering is the processing performed to ensure proper reproduction within the color range of silver halide photographic paper. In addition to compression in the above-mentioned color range, compression of gradation from 16 to 8 bits, reduction in the number of output pixels and processing in response to the output characteristic (LUT) of the output device are also included in rendering. Further, in this case, image processing of noise control, enhancement of sharpness, color balance adjustment, chroma adjustment or dodging is also carried out.

“Expanded color-range image data” is defined as the image handed from a client down to an image processing service provider, or the image obtained from the above-mentioned original image gained by the service provider photographing the client. It is the image having a color range and brightness dynamic range wider than or different from those of the output device. Preferably, it should be an image having a color range and brightness dynamic range wider than those of the output device. It has the image information containing the information other than the image information required for outputting from the output device, as described below:

The expanded color-range image is such an image as the one obtained by the image-capturing apparatus for getting an image having a color range and brightness dynamic range wider than or different from those of the output device, and the CG content having a color range and brightness dynamic range wider than or different from those of the output device. Preferably, it should be such an image as the one obtained by the image-capturing apparatus for getting an image having a color range and brightness dynamic range wider than those of the output device, and the CG content having a color range and brightness dynamic range wider than those of the output device. More preferably, it should be the image obtained by the image-capturing apparatus for getting an image having a color range and brightness dynamic range wider than those of the output device, or the CG content having a color range and brightness dynamic range wider than those of the output device.

This expanded color-range image is obtained by the scanning of a film scanner after the specified development processing has been carried out as required, for example, when the above-mentioned original image is the photographed film. When the above-mentioned original image is an image or CG content photographed by the digital camera, it is extracted from the original data, and predetermined processing is applied, as required.

“Data including the expanded color-range image data” is the image information related to the expanded color-range image, in addition to the above-mentioned expanded color-range image. When the expanded color-range image is different from the standardized scene-referred image data to be described later, correction information and the like used in the process of generating the standardized scene-referred image data from the expanded color-range image obtained in this manner are obtained as the information related thereto.

For example, it is possible to obtain the data reproduced in the process of image-capturing characteristics correction, used in the process of image-capturing characteristics correction for generating the standardized scene-referred image data from the scene-referred raw data depending on image-capturing characteristics, and to convert the scene-referred raw data and the above-mentioned reproduced data into the data including the expanded color-range image data.

“First output device” (reference output device) is defined as an output device determined by the instruction of the client receiving image processing services or by the image processing service provider. The reference output device is preferred to be a device for outputting a hardcopy image, and is more preferred to be an output device for outputting the hardcopy image to be viewed by the client receiving image processing services.

It is also possible to set multiple output devices as reference output devices. For example, two types of reference rendering information are recorded where the printer of an image processing service provider or other print service providers and that of the client are used as reference output devices, and recorded information are supplied to the client. This allows the client to generate the output-referred image data finished to meet the client's preference, by making reference to the two types of reference rendering information.

The “device characteristic data on output device” is defined as the information on the specifications and characteristics of the output device affecting the rendering conditions in the process of rendering.

The “optimization processing conditions” (rendering conditions) include processing conditions on the above-mentioned compression of color range, compression of gradation, reduction in the number of output pixels and processing in response to the output characteristic (LUT) of the output device, as well as multiple processing of noise control, enhancement of sharpness, color balance adjustment, chroma adjustment or dodging. The rendering conditions can also include the information for designating the sequence of multiple processing. When rendering conditions are recorded, it is also possible to record all processing items and processing conditions in the form associated with each other. It is also possible to record the separately set standardized rendering condition change items and/or differences in processing conditions.

The “recording of data including the expanded color-range image data and the above-mentioned first optimization processing condition data in the form associated with each other” is to record at least one piece of expanded color-range image data, information on expanded color-range image other than expanded color-range image data or reference rendering information as a separate piece of information, or to record the expanded color-range image data, information on expanded color-range image other than expanded color-range image data and reference rendering information as one integral piece of information.

When such data is recorded as a separate piece of information, use is made of the method of recording in the file recording at least one piece of information the link information of a file recording other information, and the method of recording the link information for the file recording each piece of information in a separately set information management file.

When such data is recorded as one integral piece of information, it is preferred that the information on the expanded color-range image other than the expanded color-range image data and reference rendering information be recorded as tag information in the header of the expanded color-range image data file.

When the data including the expanded color-range image data and reference rendering information are recorded as one integral piece of information, there is almost no possibility of the correspondence between the two being damaged. This method is preferable.

It is preferred that the file format for recording information be recorded in the standardized general-purpose file format such as TIFF (Tagged Image File Format), JPEG (Joint Photographic Experts Group) and Exif, not in the format inherent to an image-capturing apparatus.

The “data including the expanded color-range image data and the above-mentioned first optimization processing condition data” in the “recording step” is supplied to the client. The recorded data is made available to the client directly or via the communications network. Preferably, a portable recording medium recording the data is supplied to the client, the data is recorded on the image server of the image processing service provider connected to the network, and the data recorded on this image server is supplied to the client in the available form via the Internet and other communications network or is sent to the client with the image attached to the electronic mail. The portable recording medium recording the data includes a magnetic disk, photo-electromagnetic disk, optical disk and semiconductor recording medium.

The “image-capturing apparatus” is an apparatus equipped with an image-capturing device (image sensor) having a photoelectric conversion function. It includes a digital camera and scanner. The image-capturing device is exemplified by a CCD (Charge Coupled Device), a CCD type image-capturing device provided with color sensitivity by the combination between an electrical charge transfer mechanism called shift register and a complementary mosaic color filter, and a CMOS type image capturing device. The output current of these image-capturing devices is converted into digital form by an analog-to-digital converter. The contents of each color channel in this phase are represented by signal strength based on spectral sensitivity inherent to the image-capturing device.

The “scene-referred raw data including the image-capturing characteristics of an image-capturing apparatus” is the raw signal directly outputted from the image-capturing apparatus recording accurate information of a subject. It signifies the data itself converted into digital form by the above-mentioned analog-to-digital converter or the data obtained by correction of inherent pattern noise or dark current noise applied to the above-mentioned data. It includes the above-mentioned RAW data. This scene-referred raw data is the image data wherein there is omission of processing, such as (1) image processing of modifying the contents of data to improve the effect in viewing the image such as conversion of gradation, enhancement of sharpness and chroma enhancement, and (2) processing of mapping signal strength of each color channel based on the spectral sensitivity inherent to the image-capturing device, into the above-mentioned standardized color space such as RIMM RGB and sRGB. It is preferred that the amount of information in the output-referred image data (e.g. number of gradations) be equal to or greater than that required by the above-mentioned output-referred image data, in conformity to the performances of the above-mentioned analog-to-digital converter. For example, when the number of gradations of the output-referred image data is 8 bits per channel, the number of gradations for the scene-referred raw data is preferred to be 12 bits or more, more preferred to be 14 bits or more, and still more preferred to be 16 bits or more.

The “standardized scene-referred image data” is the data characterized in that at least the signal strength of each color channel based on the spectral sensitivity of the image-capturing device has already been mapped into the above-mentioned standardized color space such as RIMM RGB and ERIMM RGB, and image processing of modifying the contents of data to improve the effect in viewing the image such as conversion of gradation, enhancement of sharpness and chroma enhancement is omitted. It is preferred that the scene-referred image data be subjected to correction of optoelectronic conversion function of the image-capturing apparatus (opto-electronic conversion function defined in ISO1452, e.g. “Fine imaging and digital photographing” edited by the Publishing Commission of the Japan Society of Electrophotography, Corona Publishing Co., P. 449). It is preferred that the amount of information in the standardized scene-referred raw data (e.g. number of gradations) be equal to or greater than that (e.g. number of gradations) required by the output-referred image data, in conformity to the performances of the above-mentioned analog-to-digital converter. For example, when the number of gradations of the output-referred image data is 8 bits per channel, the number of gradations for the scene-referred raw data is preferred to be 12 bits or more, more preferred to be 14 bits or more, and still more preferred to be 16 bits or more.

“To generate the scene-referred image data standardized by correction of the image-capturing apparatus” is to convert the scene-referred raw data dependent on the image-capturing characteristics, into the standardized scene-referred image data. This processing depends on the status of the scene-referred raw data that depends on the image-capturing characteristics, but includes at least the processing of mapping the signal strength of each color channel based on the spectral sensitivity of the image-capturing device, into the above-mentioned standardized color space such as RIMM RGB and ERIMM RGB. For example, when the scene-referred raw data depending on the image-capturing characteristics is not subjected to the processing of interpolation based on the color filter arrangement, this processing must be applied. (For the details of the interpolation processing based of the color filter arrangement, see “Fine imaging and digital photographing” edited by the Publishing Commission of the Japan Society of Electrophotography, Corona Publishing Co., P. 51). This will provide standardized scene-referred image data where the differences of signal values among different image-capturing apparatuses are corrected, while almost the same amount of information as that of “scene-referred raw data” is retained.

“Compensation condition data for generating scene-referred image data” is defined as the data for carrying out the processing of compensating the image-capturing characteristics using only the information in data. It requires description of at least the data for mapping the signal strength of each color channel based on the spectral sensitivity of the image-capturing device, into the above-mentioned standardized color space such as RIMM RGB and ERIMM RGB, namely, the spectral sensitivity inherent to the image-capturing device or the matrix coefficient used for conversion into the standardized color space such as RIMM RGB.

For example, when only the device name of the image-capturing apparatus is described, the apparatus for carrying out this processing may not have the table for correspondence between the device name and matrix coefficient. If there is description of the URL showing the position of this information on the Internet, sufficient data for performing this processing can be said to be supplied, even if sufficient information for performing this processing is not described directly, although sufficient data cannot be said to have been supplied. The compensation condition data for carrying out such processing of image-capturing characteristics compensation is preferred to be recorded as tag information to be written into the header in the image file.

When the above-mentioned compensation condition data is stored in a medium independently of the scene-referred raw data, the compensation condition data and/or scene-referred raw data must be assigned with information for associating between the two, or with a separately management information file containing the description of linkage information.

The “server connected to the communications line” is defined as a network server connected to the communications line such as the Internet. It is installed on the side of the image processing service provider.

### BRIEF DESCRIPTION OF THE DRAWINGS

Other objects and advantages of the present invention will become apparent upon reading the following detailed description and upon reference to the drawings in which:

FIG. 1 is a block diagram representing the functions of an image processing apparatus as a first embodiment of the present invention;

FIG. 2 is a flowchart representing image processing by an image processing apparatus as a first embodiment of the present invention;

FIG. 3 is a schematic diagram representing the configuration of the tag information-equipped output-referred image data for display given in FIG. 2;

FIG. 4 is a flowchart representing rendering processing based on the rendering processing program given in FIG. 2;

FIG. 5 is a schematic diagram representing the configuration of the tag information-equipped output-referred image data file Im13 for display given in FIG. 4;

FIG. 6 is a block diagram representing the functions of an image processing apparatus as a second embodiment of the present invention;

FIG. 7 is a flowchart representing image processing by an image processing apparatus as a second embodiment of the present invention; and

FIG. 8 is a flowchart representing rendering processing based on the rendering processing program given in FIG. 7.

### DETAILED DESCRIPTION OF THE PREFERRED EMBODIMENT

The following describes the preferred embodiments of the present invention with reference to drawings:

(First Embodiment)

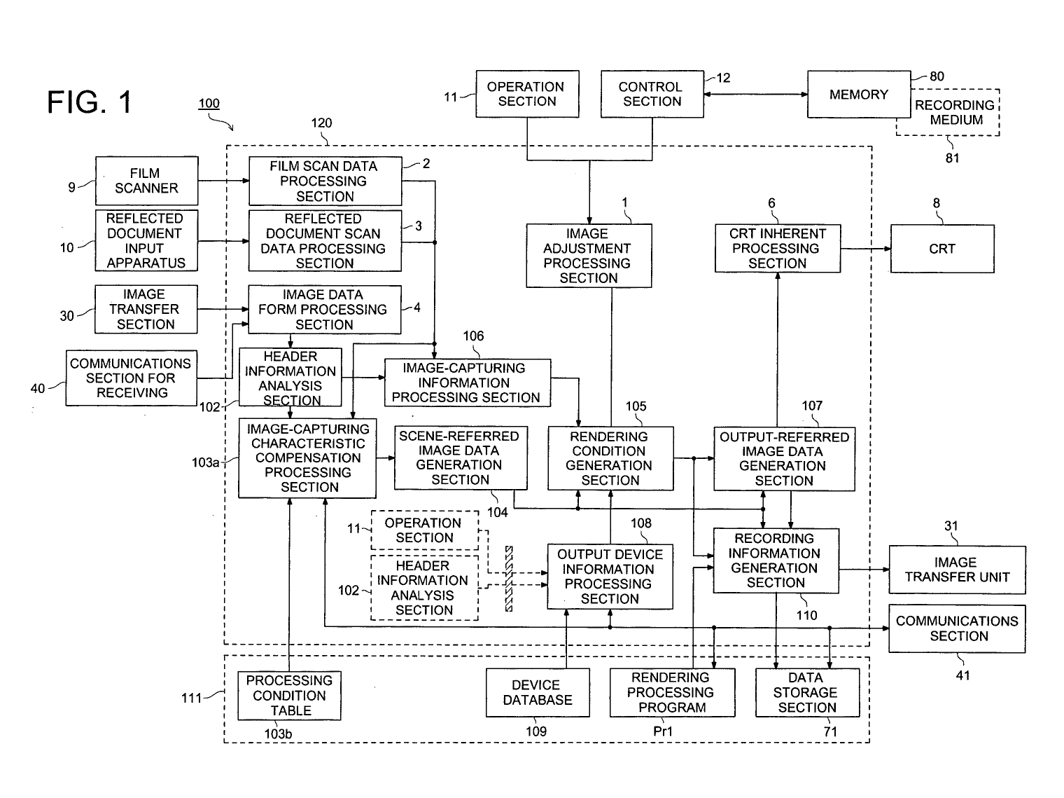

FIG. 1 is a block diagram representing the functions of an image processing apparatus 100 as a first embodiment of the present invention. The image processing apparatus 100 is installed in a system (not illustrated) of an image processing service provider.

As shown in FIG. 1, the image processing apparatus 100 comprises a film scanner 9 for inputting image data, a reflected document input apparatus 10, an image transfer section 30, a communications section for receiving 40, an image processing section 120 for providing image processing to the inputted image data, a operation section 11 for inputting various operation instructions for image processing, a control section 12 for controlling the operation of the image processing apparatus 100 including the image processing apparatus 120, a storage section 111 for storing various types of data used for image processing, a CRT 8 as the output destination of the processed image data, an image transfer unit 31 and a communications section 41.

The image processing section 120 comprises an image adjustment processing section 1 whose operation is controlled by the control section 12, a film scan data processing section 2, a reflected document scan data processing section 3, an image data form processing section 4, a CRT inherent processing section 6, a header information analysis section 102, an image-capturing characteristic compensation processing section 103a, a scene-referred image data generation section 104, a rendering condition generation section 105, an image-capturing information processing section 106, an output-referred image data generation section 107, an output device information processing section 108, and a recording information generation section 110.

The film scan data processing section 2 and reflected document scan data processing section 3 correspond to the acquisition means 3 mentioned in the Claims. The rendering condition generation section 105 corresponds to the determining means and processing condition setting means mentioned in the Claims. The output-referred image data generation section 107 corresponds to the output-referred image data generating means in the Claims. The output device information processing section 108 corresponds to the output device setting means in the Claims. The recording information generation section 110 corresponds to the recording means and differential image data generating means in the Claims. The printing information generation section 112 corresponds to the reduced image data generating means and trimming means in the Claims.

The memory section 111 is equipped with a data storage section 71, and stores the data of a processing condition table 103b, device database 109, rendering processing program Pr1 and others.

It should be noted in passing that the rendering processing program Pr1 corresponds to the optimization processing program mentioned in the Claims.

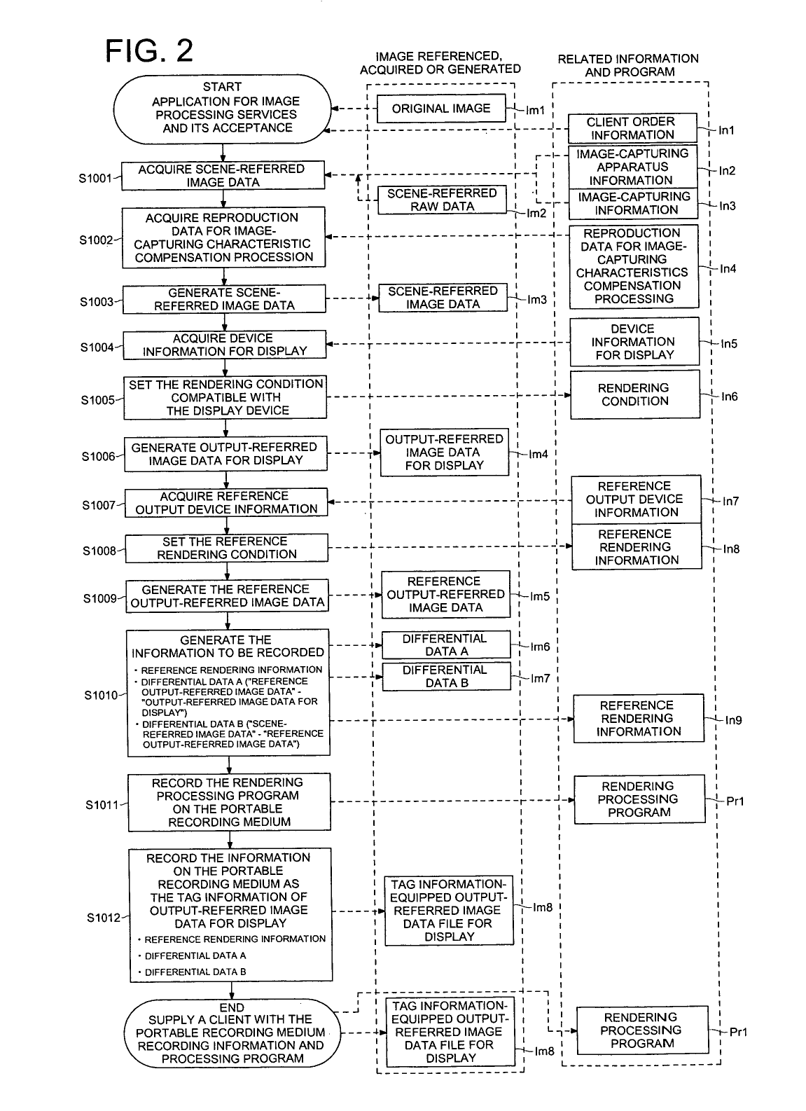

The program for controlling the operation of the above-mentioned sections constituting the image processing apparatus 120 by means of the control section 12 is stored in the memory 80 or the recording medium 81 provided removably on the image processing apparatus 100. The control section 12 runs the image processing program for performing image processing shown in the flowchart of FIG. 2, wherein the this program is stored in the memory 80 or the recording medium 81 in particular.

To put it another way, based on the instruction inputted from the operation section 11 and the control by the control section 12 running the image processing program, the image processing apparatus 120 applies image processing to the image data having been inputted through the film scanner 9, reflected document input apparatus 10, image transfer section 30 or communications section for receiving 40, and outputs the image data having been subjected to image processing, to the CRT 8, image transfer unit 31 or communications section 41.

After calibration inherent to the film scanner 9, negative/position reversion in the case of a negative original, removal of dirt and scratches, gray balance adjustment, contrast adjustment, removal of granular noise and sharpness enhancement have been applied to the image data inputted from the film scanner 9, the film scan data processing section 2 sends signals to the scene-referred image data generation section 104 through the image-capturing characteristic compensation processing section 103a. Further, the film scan data processing section 2 sends film size, negative/positive type, information on the subject optically or magnetically recorded on the film and information on photographing conditions (e.g. information described in APS) to the image-capturing information processing section 106.

After calibration inherent to the reflected document input apparatus 10, negative/positive reversion in the case of a negative original, removal of dirt and scratches, gray balance adjustment, contrast adjustment, removal of granular noise and sharpness enhancement have been applied to image data inputted from the reflected document input apparatus 10, the reflected document scan data processing section 3 sends signals to the scene-referred image data generation section 104 through the image-capturing characteristic compensation processing section 103a.

The exposure processing section 13 performs decompression of compressed data or conversion of the color data representation method, as required, and sends the signals to the header information analysis section 102, according to the format of the image data inputted from the image transfer section 30 connectable with the adaptor for various types of portable recording media or the digital camera of an image processing service provider, and the image data inputted from the communications section for receiving 40 that can be connected to the leased communications line of the image processing service provider and public line including the Internet.

The header information analysis section 102 extracts image-capturing apparatus information In2, image-capturing information In3, and scene-referred raw data Im2 from the image film header section. The header information analysis section 102 sends the extracted image-capturing apparatus information In2 to the image-capturing characteristic compensation processing section 103a, the extracted image-capturing information In3 to the image-capturing information processing section 106, and the extracted scene-referred raw data Im2 to the scene-referred image data generation section 104.

The image-capturing characteristic compensation processing section 103a sends the processing conditions to the scene-referred image data generation section 104, wherein these processing conditions have been determined, for example, by getting information in response to an image-capturing apparatus from the processing condition table 103b in the memory section 111.

The scene-referred image data generation section 104 applies image-capturing characteristics compensation processing conditions to the scene-referred raw data Im2 to generate scene-referred image data Im3. The generated scene-referred image data Im3 is sent to the rendering condition generation section 105, output-referred image data generation section 107 and recording information generation section 110.

Here the scene-referred image data Im3 corresponds to the data including the expanded color-range image data o scene-referred image data mentioned in the Claims.

Based on the image-capturing apparatus information In2, the image-capturing information processing section 106 determines the image processing conditions on the generation of output-referred image data.

It is also possible to arrange such a configuration that reference output device specification information is inputted from the operation section 11. Alternatively, when the reference output device specification information from a client to the image processing service provider is included as order information In1 in the header of the image data received by the communications section for receiving 40 or the image data obtained by the image transfer section 30, reference output device specification information is extracted by the header information analysis section 102. The extracted header information analysis section 102 is sent to the output device information processing section 108. Such a configuration can also be arranged.

The output device information processing section 108 acquires the device characteristic information corresponding to the specified device from the device database 109 in the memory section 111, or from the external database through the communications section 41 via the communications network, and sends it to the rendering condition generation section 105.

Based on the inputted scene-referred image data Im3, output device characteristic information, image processing condition created by the image-capturing information processing section 106 and specifications inputted from the operation section, the rendering condition generation section 105 creates the rendering condition, and sends the created rendering condition to the output-referred image data generation section 107 and recording information generation section 110. The rendering condition generation section 105 acquires a template from a template database (not illustrated) in response to the instruction from the operation section 11 or the above-mentioned order information In1, and forms a composite image by merging such dada. Such a configuration can also be arranged.

The output-referred image data generation section 107 applies image processing to scene-referred image data Im3 according to the above-mentioned rendering condition, and generates the output-referred image data.

Various processing described above uses the output device as a display device and reference output device.

The output-referred image data generation section 107 sends the output-referred image data generated by specifying the output device as a display device, to the CRT inherent processing section 6 and recording information generation section 110. The CRT inherent processing section 6 applies a pixel count change or color matching to the received output-referred image data as required. Then image data for display merged with the information that must be displayed such as control information is sent to the CRT 8.

The output-referred image data generation section 107 sends to the recording information generation section 110 the output-referred image data (i.e. reference output-referred image data Im5) generated by specifying the output device as a reference output device.

It should be noted in passing that the reference output-referred image data Im5 corresponding to the first output-referred image data mentioned in the Claims.

The recording information generation section 110 acquires rendering processing program Pr1 for a client from the memory section 111, and sends it to the image transfer unit 31.

Based on the inputted scene-referred image data Im3, output-referred image data Im4 for display, reference output-referred image data Im5 and rendering conditions used to generate the reference output-referred image data Im5, the recording information generation section 110 generates;

differential data A Im6 (differential data of “reference output-referred image data Im5”—“output-referred image data Im4 for display”) to be recorded as tag information in the header of the image file of the output-referred image data Im4 for display,

differential data B Im7 (differential data of “scene-referred image data Im3”—“scene-referred image data Im3”), and

reference rendering information In9. Then the recording information generation section 110 sends them to the exposure processing section 31 and data storage section 71. The reference rendering information In9 is the information representing the reference rendering information In8 itself or information for generating reference rendering information In8.

It should be noted in passing that the output-referred image data Im4 for display corresponds to the reduced image data or the second output-referred image data mentioned in the Claims. The differential data A Im6 corresponds to the third differential data in the Claims, and the differential data B Im7 corresponds to the first differential image data or second differential image data in the Claims. The data gained by adding the differential data B Im7 to the differential data A Im6 corresponds to the first differential image data mentioned in the Claims. Further, the reference rendering information In9 corresponds to the first optimization processing condition data.

The image transfer unit 31 is equipped with a floppy disk adaptor, MO (magneto-optical disk) adaptor and optical disk adaptor so that the portable recording mediums such as floppy disk, MO disk and CD-R can be used. Rendering processing program Pr1 for client, image data and rendering information, having been received from the recording information generation section 110, are recorded on the portable recording medium.

The client is provided with the portable recording medium where rendering processing program Pr1 for client, image data and rendering information are recorded.

In the first embodiment, the rendering processing program Pr1 for client, image data and rendering information are recorded on the-portable recording medium and are supplied to the client. However, the present invention is not restricted thereto. It is also possible to arrange such a configuration that the image data and rendering information stored in the data storage section 71, and part or whole of the rendering processing program Pr1 for client are supplied to the client by the communications section 41 through wired means or wireless means such as the leased line of the image processing service provider and/or public line like the Internet. When the Internet is used, it is preferred that such data be sent in the form of an electronic mail and/or information attached thereto, or an image processing service site be provided to disclose the image and to accept applications for image processing services.

The following describes the operations in the first embodiment.

FIG. 2 is a flowchart representing image processing by an image processing apparatus 100 as the first embodiment of the present invention. Image processing shown in this flowchart is realized when the image processing program stored in the memory 80 and recording medium 81 is run by the control section 12.

The image, related information and program referenced, acquired or generated in each step of the flowchart are also shown in FIG. 2.

In the first place, the image processing service provider accepts application for services through the shop counter, unmanned terminal or communications network such as the Internet, and acquires order information In1 and original image Im1 from the client. The order information In1 is supplied to the client in the form integral with the image, as the information recorded by APS file information recording means and header information of a digital image data file.

Step S1001

When the original image Im1 is a photographed film or photographic print, after development processing has been completed as required, the control section 12 controls the film scan data processing section 2 to get the scene-referred raw data Im2 from the film scanner 9. At the same time, it acquires the information on the image-capturing characteristics of the film scanner 9 used to capture the image, as image-capturing apparatus information In2. Further, when the original image Im1 is a digital image having been captured by a digital camera and others, and this digital image has been inputted through the image transfer section 30 or communications section for receiving 40, then the control section 12 controls the image data form processing section 4 to analyze the data structure of this digital image, and to get the scene-referred raw data Im2 and image-capturing apparatus information In2 at the same time.

It is also possible to arrange such a configuration that the control section 12 controls the scene-referred image data Im3 to get the scene-referred raw data Im2 and image-capturing apparatus information In2 from the image data inputted through the reflected document input apparatus 10.

It should be noted in passing that, if the image data is the scene-referred image data Im3 having been subjected to the processing of image-capturing characteristic compensation, the control section 12 goes to step S1004. Further, when information at the time of image capturing has been assigned in step S1001, the control section 12 acquires the information at the time of image capturing as image-capturing information In3.

Step S1002

The control section 12 controls the image-capturing characteristic compensation processing section 103a to get reproduction data In4 for image-capturing characteristics compensation processing from the processing condition table 103b.

Step S1003

Based on the scene-referred raw data Im2 and reproduction data In4 for image-capturing characteristics compensation processing, the control section 12 controls the scene-referred image data generation section 104 to generate the standardized scene-referred image data Im3.

Step S1004

The control section 12 controls the output device information processing section 108 to device information In5 for display recorded on the device database 109.

Step S1005

Based on the device information In5 for display, the control section 12 controls the rendering condition generation section 105 to set the rendering condition In6 compatible with the display device used in the next processing of generating the output-referred image data Im4 for display.

It should be noted in passing that information for indicating the rendering condition In6 itself compatible with the display device or the information for generating the rendering condition In6 compatible with display device corresponds to the second optimization processing condition data mentioned in the Claims.

Step S1006

Based on the e rendering condition In6 compatible with the display device, the control section 12 controls the output-referred image data generation section 107 to generate the output-referred image data Im4 for display.

It is also possible to arrange such a configuration that, in steps S1005 and S1006, repeated processing is carried out by changing the rendering condition and/or sequence of processing from the operation section 11 and control section 12 through the image adjustment processing section 1.

Step S1007

Based on the client order information In1, the control section 12 controls the output device information processing section 108 to determine the reference output device and to get the reference output device information In7 from the device database 109 at the same time.

If no reference output device is specified by the client at the time of application for image processing services and acceptance of the application, it can be set as appropriate at the discretion of the image processing service provider, for example, by making reference to the past orders of the client in the client database (not illustrated) and setting the reference output device. Such a configuration can also be arranged.

The following description will continue on the assumption that the reference output device is an inkjet printer regularly used by a client:

Step S1008

Based on the obtained reference output device information In7, the control section 12 controls the rendering condition generation section 105 to set the rendering condition that is used in the next processing of generating the reference output-referred image data Im5 compatible with the inkjet printer of the client as a reference output device, i.e. the reference rendering information In8.

It should be noted that, when the image-capturing information In3 has been obtained, it is also possible to arrange such a configuration as to adjust the rendering condition in response to image-capturing information In3. Further, it is also possible to arrange such a configuration as to get a template image from the database or from the outside and to superimpose it onto the image to be processed.

Step S1009

Based on the rendering condition In6, the control section 12 controls the output-referred image data generation section 107 to generate the reference output-referred image data Im5.

It is also possible to arrange such a configuration that, in steps S1008 and S1009, repeated processing is carried out, for example, by changing the rendering condition and/or sequence of processing from the operation section 11 and control section 12 through the image adjustment processing section 1.

Step S1010

The control section 12 generates the information recorded as shown below:

(1) The control section 12 controls the recording information generation section 110 to generate the information for giving the reference rendering information In8 used for generation of the reference output-referred image data Im5 as reference rendering information In9.

When the reference rendering information In9 is recorded, it is also possible to arrange such a configuration that all processing items and processing conditions are recorded in the form associated with each other. Alternatively, it is also possible to make such arrangements as to record the items changed from the separately set standardized rendering conditions and/or differences in processing conditions.

(2) The control section 12 controls the recording information generation section 110 to generate the differential data of “reference output-referred image data Im5”—“output-referred image data Im4 for display” as differential data A Im6.

(3) The control section 12 controls the recording information generation section 110 to generate the differential data of “scene-referred image data Im3”—“reference output-referred image data Im5” as differential data B Im7.

Step S1011

The control section 12 controls the recording information generation section 110 to record the rendering processing program Pr1 for the client on the portable recording medium (not illustrated) stored in the image transfer unit 31.

Step S1012

The control section 12 controls the recording information generation section 110 to record the tag information-equipped output-referred image data for display Im8 wherein the reference rendering information In9, differential data A Im6 and differential data B Im7 are added to the header of the image file of the output-referred image data Im4 for display as tag information; wherein the tag information-equipped output-referred image data for display Im8 is recorded on the portable recording medium with the above-mentioned rendering processing program Pr1 for client recorded therein. In this case, it is possible to arrange such a configuration that the image-capturing information In3 is also recorded as tag information.

Subsequent to step S1012, the image processing service provider supplies the client with a portable recording medium that records the tag information-equipped output-referred image data for display Im8 that contains the reference rendering information In9, differential data A Im6 and differential data B Im7 as tag information and the rendering processing program Pr1 for client. Further, the image processing service provider can send an additional bill in conformity to the data and program to be provided.

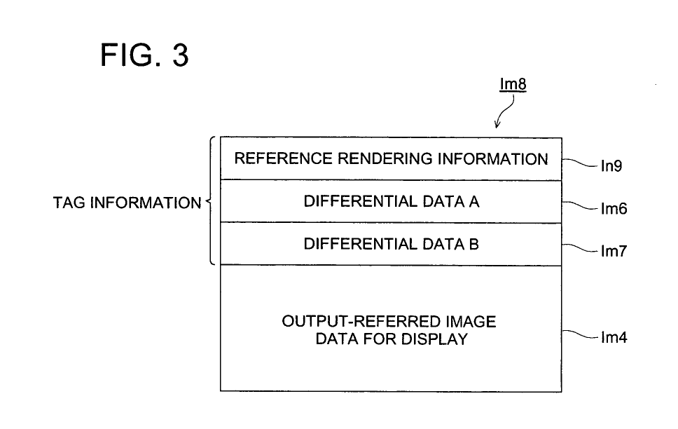

FIG. 3 is a schematic diagram representing the configuration of the tag information-equipped output-referred image data for display Im8. As shown in FIG. 3, for the tag information-equipped output-referred image data for display Im8, the reference rendering information In9, differential data A Im6 and differential data B Im7 are recorded on the header of the image file as tag information of the output-referred image data Im4 for display.

In the first embodiment, differential data A Im6 capable of reconfiguring the output-referred image data Im4 for display and reference output-referred image data Im5;

differential data B Im7 capable of reconfiguring the scene-referred image data Im3;

reference rendering information In9; and

rendering processing program Pr1 for client are recorded on one and the same portable recording medium and are supplied to the client. However, the present invention is not restricted to only these. Part of the above-mentioned information can be recorded on another portable recording medium, or part or whole of the above-mentioned information can be supplied to a client through the communications network.

The following describes the rendering processing based on the rendering processing program Pr1:

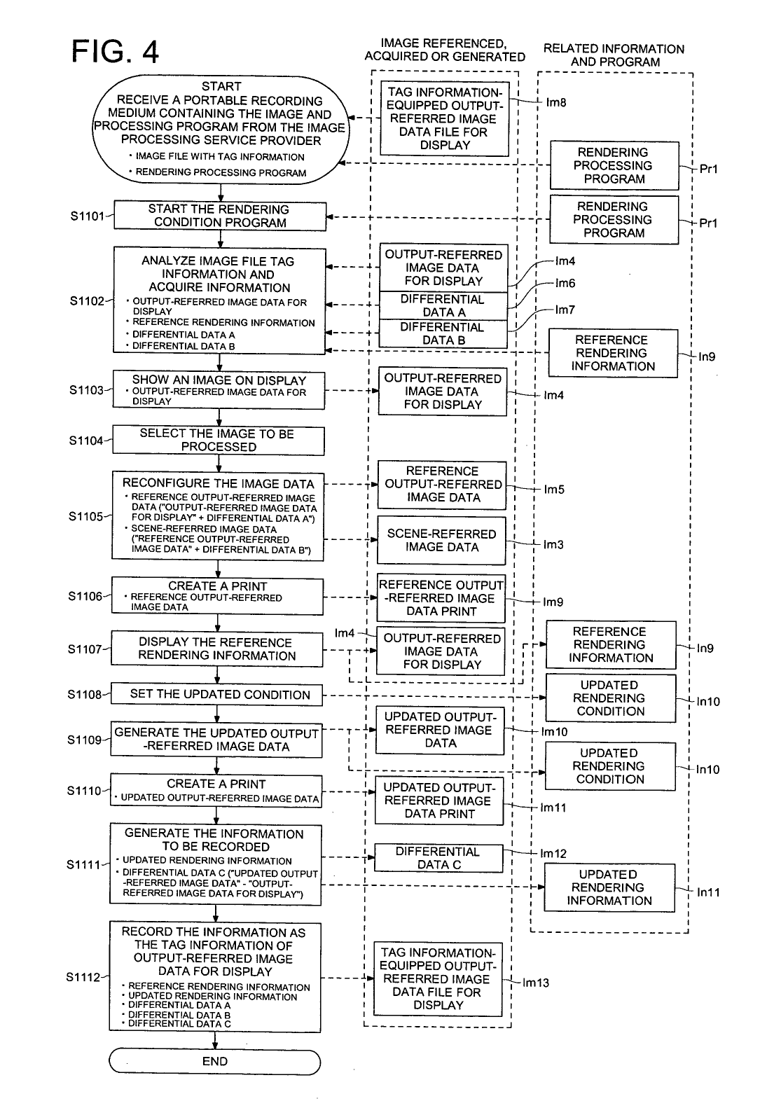

FIG. 4 is a flowchart representing rendering processing based on the rendering processing program Pr1 for client. Rendering processing shown in this flowchart is realized when the CPU of the un-illustrated PC (personal computer) regularly used by the client (hereinafter referred to as “client CPU”) executes the rendering processing program Pr1 provided by the image processing service provider.

FIG. 4 also shows the image, related information and program referenced, acquired or generated in each step of this flowchart.

From the image processing service provider, the client receives the tag information-equipped output-referred image data for display Im8 and rendering processing program Pr1. (To put it another way, the client stores and installs such data and program in his or her own PC).

Step S1101

The client CPU starts the received rendering processing program Pr1.

Step S1102

Based on the rendering processing program Pr1, the client CPU analyzes the tag information of the tag information-equipped output-referred image data for display Im8, and acquires the information including the output-referred image data Im4 for display, reference rendering information In9, differential data A Im6 and differential data B Im7.

Step S1103:

The client CPU displays the output-referred image data Im4 for display on the display unit (not illustrated). In this case, it is preferred that the client CPU generate and display the thumbnail image of a small pixel count, as required. It is preferred that the thumbnail image be generated by the image processing service provider and be recorded in the form associated with the information for giving scene-referred image data Im3 and reference rendering information In9. It is also possible to arrange such a configuration that the thumbnail image is recorded as tag information in the header of the tag information-equipped output-referred image data for display Im8.

Step S1104

The client CPU receives the instruction for specifying the image inputted by the client where this image is to be processed.

Step S1105

When the image to be processed has been specified, the client CPU reconfigures the image data used for the processing as follows, based on the rendering processing program Pr1:

(1) Output-referred image data Im4 for display and differential data A Im6 are merged to reconfigure the reference output-referred image data Im5.

(2) Reference output-referred image data Im5 and differential data B Im7 are merged to reconfigure the scene-referred image data Im3.

Step S1106

The client CPU outputs the reference output-referred image data Im5 to the inkjet printer set on the reference output device, and creates a hardcopy print (reference output-referred image data print Im9).

The first embodiment is based on the assumption that, when application is made for an image processing service, the client has notified the image processing service provider that the inkjet printer regularly used by the client should be used as the reference output device. However, the present invention is not restricted to this assumption.

Step S1107

The client CPU displays the reference rendering information In9 associated with the image to be processed.

Step S1108

Based on the client specification given by making reference to the reference output-referred image data print Im9 (hardcopy print) created by outputting the reference rendering information In9 and reference output-referred image data Im5 to the client inkjet as a reference output device, the client CPU sets the rendering condition used to generate the updated output-referred image data Im10 for creating the print finished to meet the client's preference, i.e. updated rendering condition In10.

The reference rendering information In9 is displayed in response to the image to be processed. At the same time, reference output-referred image data print Im9 (hardcopy print) created by outputting the reference output-referred image data Im5 to the client inkjet printer as the reference output device is also displayed. Accordingly, by making reference to them, the client can easily set the updated output-referred image data In10.

It should be noted in passing that the updated output-referred image data Im10 corresponds to the fourth output-referred image data mentioned in the Claims.

Step S1109

Based on the updated rendering condition In10, the client CPU applies image processing such as rendering to the scene-referred image data Im3, and generates new output-referred image data, i.e. the updated output-referred image data Im10.

Step S1110

The client CPU outputs the updated output-referred image data Im10 to the client inkjet printer as a reference output device and creates updated output-referred image data print Im11.

Step S1111

The client CPU generates the information to be recorded as shown below:

(1) The client CPU generates the information for giving updated rendering condition In10 as updated rendering information In11. The updated rendering information In11 is the information for denoting the updated rendering condition In10 itself or information for generating the updated rendering condition 10.

When the updated rendering information In11 is recorded, it is also possible to arrange such a configuration that it is recorded in the form associated with all processing items and processing conditions, or the updated items from the separately set standardized rendering conditions and/or differences in processing conditions are recorded. Alternatively, it is possible to make arrangements so that the updated items from the reference rendering information In9 and differences in processing conditions are recorded.

(2) The client CPU generates the differential data of “updated output-referred image data Im10”—“output-referred image data Im4 for display” as differential data C Im12. The updated rendering information In11 corresponds to the fourth optimization processing condition data mentioned in the Claims.

Step S1112

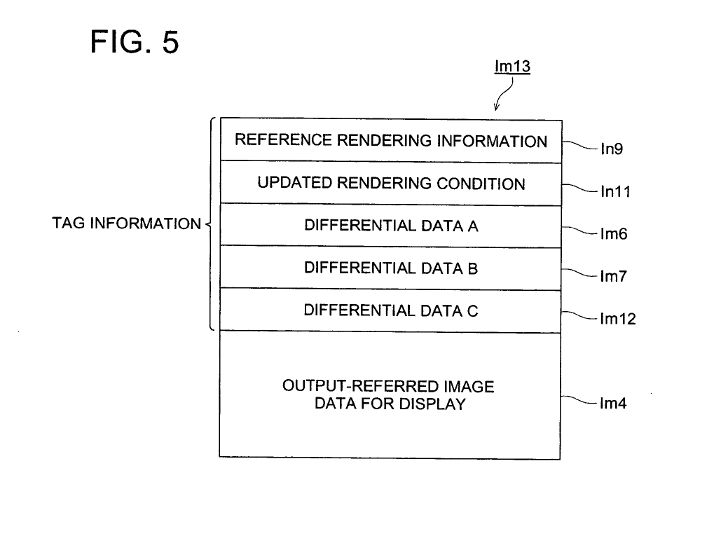

The client CPU records the reference rendering information In9, updated rendering information In11, differential data A Im6, differential data B Im7 and differential data C Im12 as tag information-equipped output-referred image data file Im13 for display where the tag information is added to the header of the output-referred image data Im4 for display. (See FIG. 5).

In this case, image-capturing information In3 can also be recorded as tag information. Further, at the discretion of the client it is possible to go back to the step S1108 to reset the updated rendering condition In10. In step S1110, if the updated output-referred image data print Im11 (hardcopy) of the updated output-referred image data created by outputting the updated output-referred image data Im10 to the client's ink jet printer as a reference output device has been finished to meet the client's preference, then the updated rendering information In11 can be recorded as reference rendering information In9. Alternatively, updated output-referred image data Im10 can be recorded as new reference output-referred image data Im5. Further, when updated output-referred image data Im10 is to be set and recorded as new reference output-referred image data Im5, scene-referred image data Im3, updated rendering information In11 and updated output-referred image data Im10 can be recorded in the form associated with each other. It is also possible to arrange such a configuration as to find the differential data D (not illustrated) of “scene-referred image data Im3”—“updated output-referred image data Im10” and to record the updated rendering information In11, differential data C Im12 and the above-mentioned differential data D as tag information of tag information-equipped output-referred image data file Im13 for display.

FIG. 5 schematically represents the configuration of the tag information-equipped output-referred image data file Im13 for display. As shown in FIG. 5, in the tag information-equipped output-referred image data file Im13 for display, reference rendering information In9, updated rendering information In11, differential data A Im6, differential data B Im7 and differential data C Im12 are recorded on the header of the tag information of the output-referred image data Im4 for display.

As described above, the reference rendering information In9 and reference output-referred image data print Im9 (hardcopy) created by outputting the reference output-referred image data Im5 to the ink jet printer as a reference output device are displayed. This allows the client to set the updated rendering condition In10 easily, and to create the updated output-referred image data print Im11 (hardcopy) meeting the client's preferences, when the updated output-referred image data Im10 generated on the basis of the updated rendering condition In10 is outputting to the client's ink jet printer as a reference output device.

(Second Embodiment)

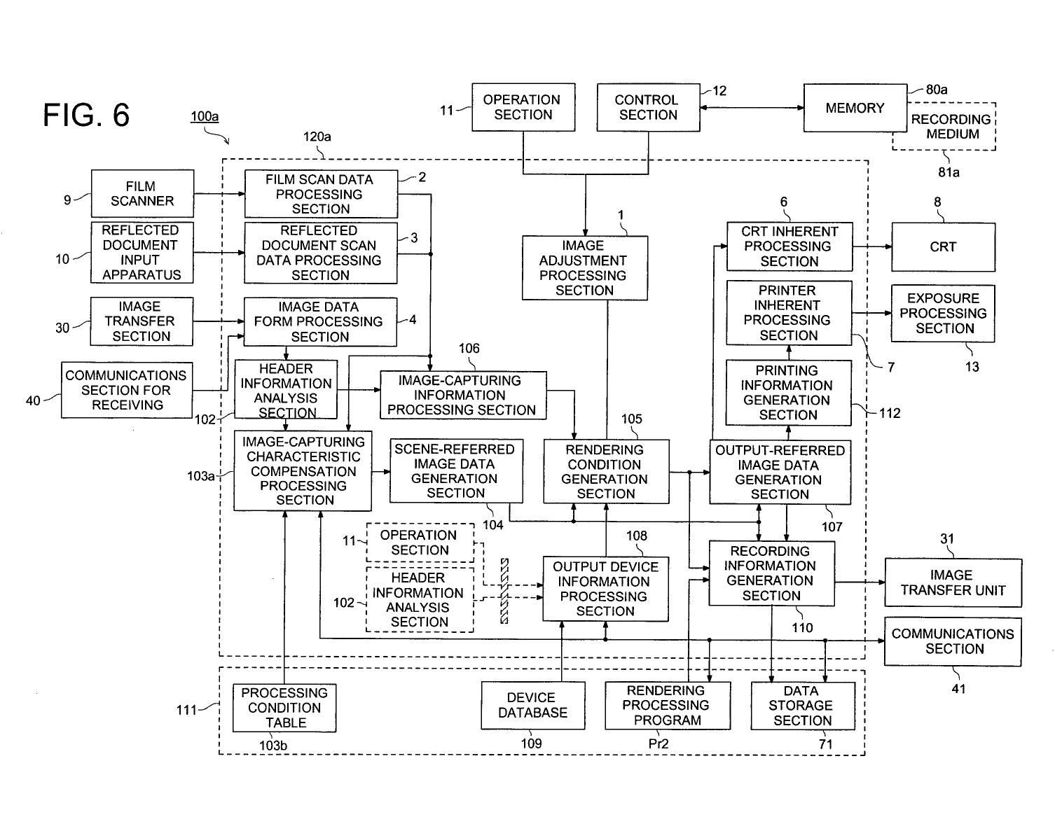

FIG. 6 is a block diagram representing the functions of an image processing apparatus 200 as a second embodiment of the present invention. The image processing apparatus 200 is mounted in the system (not illustrated) of the image processing service provider.

As shown in FIG. 6, the image processing apparatus 200 comprises a film scanner 9, a reflected document input apparatus 10, an image transfer section 30, a communications section for receiving 40, an image processing section 120a for providing image processing to the inputted image data, an operation section 11 for inputting the various operation instructions for image processing, a control section 12 for controlling the operation of the image processing apparatus 100 including the image processing section 120, a memory section 111 for storing various types of data used for mage processing, a CRT 8 as the output destination of the processed image data, an exposure processing section 13 an image transfer unit 31 and a communications section 41.

The image processing section 120a comprises an image adjustment processing section 1 whose operation is controlled by the control section 12, a film scan data processing section 2, a reflected document scan data processing section 3, an image data form processing section 4, a CRT inherent processing section 6, a printer inherent processing section 7, a header information analysis section 102, an image-capturing characteristic compensation processing section 103a, a scene-referred image data generation section 104, a rendering condition generation section 105, an image-capturing information processing section 106, n output-referred image data generation section 107, an output device information processing section 108, a recording information generation section 110 and a printing information generation section 112.

A printer inherent processing section 7 corresponds to print creating means mentioned in the Claims.

The memory section 111 is equipped with a data storage section 71, and stores the data of a processing condition table 103b, device database 109, rendering processing program Pr2 and others.

It should be noted in passing that the rendering processing program Pr2 corresponds to the optimization processing program mentioned in the Claims.

The program for controlling the operation of the above-mentioned sections constituting the image processing apparatus 120 by means of the control section 12 is stored in the recording medium 80a or recording medium 81a mounted removably on the image processing apparatus 100.

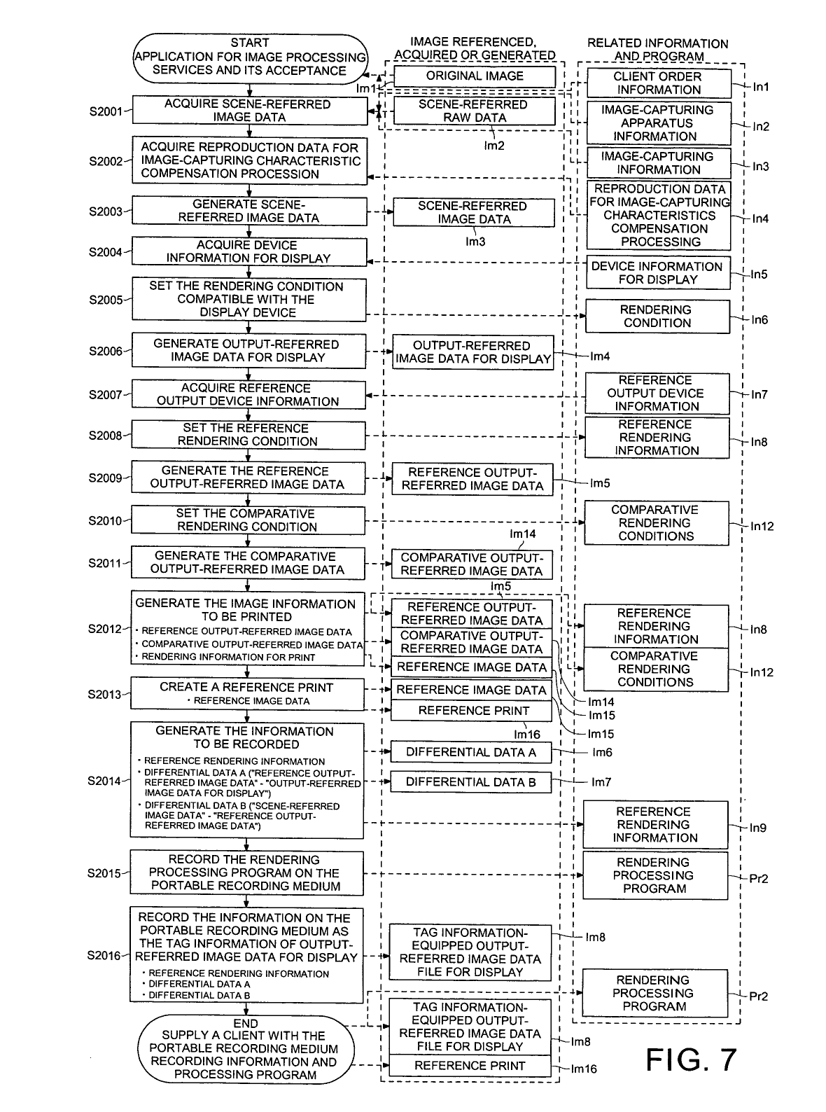

The control section 12 runs the image processing program for performing image processing shown in the flowchart of FIG. 7, wherein this program is stored in the memory 80a or the recording medium 81a in particular.

To put it another way, based on the instruction inputted from the operation section 11 and the control by the control section 12 running the image processing program, the image processing apparatus 120a applies image processing to the image data having been inputted through the film scanner 9, reflected document input apparatus 10, image transfer section 30 or communications section for receiving 40, and outputs the image data having been subjected to image processing, to the CRT 8, exposure processing section 13, image transfer unit 31 or communications section 41.

After calibration inherent to the film scanner, negative/positive reversion in the case of a negative original, removal of dirt and scratches, gray balance adjustment, contrast adjustment, removal of granular noise and sharpness enhancement have been applied to the image data inputted from the film scanner 9, the film scan data processing section 2 sends signals to the scene-referred image data generation section 104 through the image-capturing characteristic compensation processing section 103a. Further, the film scan data processing section 2 sends film size, negative/positive type, information on the subject optically or magnetically recorded on the film and information on photographing conditions (e.g. information described in APS) to the image-capturing information processing section 106.

After calibration inherent to the reflected document input apparatus 10, negative/position reversion in the case of a negative original, removal of dirt and scratches, gray balance adjustment, contrast adjustment, removal of granular noise and sharpness enhancement have been applied to image data inputted from the reflected document input apparatus 10, the reflected document scan data processing section 3 sends signals to the scene-referred image data generation section 104 through the image-capturing characteristic compensation processing section 103a.

The exposure processing section 13 performs decompression of compressed data or conversion of the color data representation method, as required, and sends the signals to the header information analysis section 102, according to the format of the image data inputted from the image transfer section 30 connectable with the adaptor for various types of portable recording media or the digital camera of an image processing service provider, and the image data inputted from the communications section for receiving 40 that can be connected to the leased communications line of the image processing service provider and public line including the Internet.

The header information analysis section 102 extracts image-capturing apparatus information In2, image-capturing information In3, and scene-referred raw data Im2 from the image film header section. The header information analysis section 102 sends the extracted image-capturing apparatus information In2 to the image-capturing characteristic compensation processing section 103a, the extracted image-capturing information In3 to the image-capturing information processing section 106, and the extracted scene-referred raw data Im2 to the scene-referred image data generation section 104.

The image-capturing characteristic compensation processing section 103a sends the processing conditions to the scene-referred image data generation section 104, wherein these processing conditions have been determined, for example, by getting information in response to an image-capturing apparatus from the processing condition table 103b in the memory section 111.

The scene-referred image data generation section 104 applies image-capturing characteristics compensation processing conditions to the scene-referred raw data Im2 to generate scene-referred image data Im3. The generated scene-referred image data Im3 is sent to the rendering condition generation section 105, output-referred image data generation section 107 and recording information generation section 110.

Based on the image-capturing apparatus information In2, the image-capturing information processing section 106 determines the image processing conditions on generation of the output-referred image data.

This embodiment assumes that the reference output device is the photographic printer of an image processing service provider (exposure processing section 13).

Similarly to the first embodiment, the reference output device is specified by the input from the operation section 11. Not only that, when the header information of the image data received by the communications section for receiving 40 or captured by the image transfer section 30 and reference output device specification information from the client to the image processing apparatus are included in the client order information In1, such information is captured by the header information analysis section 102. The captured reference output device specification information is sent to the output device information processing section 108. The output device information processing section 108 acquires the device characteristic information corresponding to the specified device from the device database 109 in the memory section 111 or external database through the communications network and sends it to the rendering condition generation section 105. Such a configuration can also be arranged.

Based on the inputted scene-referred image data Im3, output device characteristic information, image processing condition created by the image-capturing information processing section 106 and specifications inputted from the operation section, the rendering condition generation section 105 creates the rendering condition, and sends the created rendering condition to the output-referred image data generation section 107 and recording information generation section 110. The rendering conditions so preset as to compatible with the photographic printer (exposure processing section 13) of the image processing service provider as a reference output device are also sent to the printing information generation section 112.

It is also possible to arrange such a configuration that, in response to the instructions from the operation section 11 or the above-mentioned order information In1, the rendering condition generation section 105 acquires a template from the template database (not illustrated) to form a composite image by superimposition.

Based on the above-mentioned rendering conditions, the output-referred image data generation section 107 applies image processing to the scene-referred image data Im3, and to generate the output-referred image data.

Various types of the above-mentioned processing are carried out sequentially through the output device display device and the photographic printer (exposure processing section 13) of the image processing service provider as reference output device.

Similarly, it is also possible to set rendering conditions different in the processing conditions and/or sequence of processing from the reference rendering information In8 compatible with the above-mentioned reference output device, i.e. comparative rendering conditions In12, while the output device is the photographic printer (exposure processing section 13) of the image processing service provider as reference output device. Based on this comparative rendering conditions In12, comparative output-referred image data Im14 is generated, and more than two comparative rendering conditions In12 are set to produce multiple pieces of comparative output-referred image data Im14. Such a configuration can also be arranged.

In this case, the comparative output-referred image data Im14 corresponds to the third output-referred image data mentioned in the Claims. Further, the information for indicating the comparative rendering conditions In12 itself or the information for generating the comparative rendering condition In12 corresponds to the third optimization processing condition data mentioned in the Claims.

The output-referred image data generation section 107 sends the output-referred image data generated by specifying the output device as the display device, to the CRT inherent processing section 6 and recording information generation section 110. The CRT inherent processing section 6 applies processing of changing the pixel count and color matching to the received output-referred image data, as required. It then sends to the CRT 8 the image data for display merged with the information requiring display of control information or the like.

When the output device is the photographic printer (exposure processing section 13) of the image processing service provider as reference output device, the rendering condition serving as reference (i.e. reference rendering information In8) and the output-referred image data (i.e. reference output-referred image data Im5) generated based on this reference rendering condition are sent to the recording information generation section 110 and printing information generation section 112. Comparative rendering conditions In12 different in processing conditions and/or sequence of processing from the reference rendering condition with the output device being the photographic printer (exposure processing section 13) of the image processing service provider as reference output device, and comparative output-referred image data Im14 generated based on this comparative rendering conditions In12 are sent to the printing information generation section 112.

The printing information generation section 112 acquires the reference output-referred image data Im5, output-referred image data Im4 for display and rendering conditions corresponding to each piece of image data to perform specified image reduction, trimming and other processing. It also organizes the rendering conditions attached to the print image and sends them to the printer inherent processing section 7.

The printer inherent processing section 7 carries out calibration inherent to the printer, color matching and change of the pixel count, as required, and sends the image data to the exposure processing section 13.

The exposure processing section 13 outputs the image data based on the reference output-referred image data Im5 containing the received rendering information and comparative output-referred image data Im14, and creates a reference print Im16.

It is also possible to arrange such a configuration that detailed rendering conditions, simplified usage of the rendering processing program Pr2 to be supplied to the client and image processing service ordering procedure are printed on the back of the reference print Im16 by the back printing function (not illustrated) of the exposure processing section 13 (i.e. photographic print).

The recording information generation section 110 acquires the rendering processing program Pr2 for client from the memory 111, and sends it to the image transfer unit 31.

The recording information generation section 110 generates:

differential data A Im6 (differential data of “reference output-referred image data Im5”—“output-referred image data Im4 for display”) recorded on the header of the image file of the output-referred image data Im4 for display,

differential data B Im7 (differential data of “scene-referred image data Im3”—“reference output-referred image data Im5”) and

reference rendering information In9; from:

a scene-referred image data Im3,

a output-referred image data Im4 for display,

a reference output-referred image data Im5 and

a rendering condition used to generate the reference output-referred image data Im5. Then the recording information generation section 110 sends such data to the image transfer unit 31 and data storage section 71.

The data storage section 71 records the image data and rendering information received from the recording information generation section 110, into the database and sends the image data and rendering information to the communications section 41, as required.

The image transfer unit 31 is equipped with a floppy disk adaptor, MO (magneto-optical disk) adaptor and optical disk adaptor so that the portable recording mediums such as floppy disk, MO disk and CD-R can be used. Rendering processing program Pr2 for client, image data and rendering information, having been received from the recording information generation section 110, are recorded on the portable recording medium.

The client is provided with the portable recording medium where rendering processing program Pr2 for client, image data and rendering information are recorded, and reference print Im16.

In the second embodiment, the rendering processing program Pr2 for client, image data and rendering information are recorded on the portable recording medium and are supplied to the client. However, the present invention is not restricted thereto. Similarly to the case of the above-mentioned first embodiment, it is also possible to arrange such a configuration that

the image data and rendering information stored in the data storage section 71, and part or whole of the rendering processing program Pr2 for client are supplied to the client by the communications section 41 through wired means or wireless means such as the leased line of the image processing service provider and/or public line like the Internet.

The following describes the operation of the second environment:

FIG. 7 is a flowchart representing image processing by an image processing apparatus 200 as a second embodiment of the present invention. Image processing shown in this flowchart is realized when the image processing program stored in the memory 80a and recording medium 81a is run by the control section 12.

FIG. 7 also shows the image, related information and program referenced, acquired or generated in each step of this flowchart.

In the first place, the image processing service provider accepts application for services through the shop counter, unmanned terminal or communications network such as the Internet, and acquires order information In1 and original image Im1 from the client. The order information In1 is supplied to the client in the form integral with the image, as the information recorded by APS film information recording means and header information of a digital image data file.

Step S2001

When the original image Im1 is a photographed film or photographic print, after development processing has been completed as required, the control section 12 controls the film scan data processing section 2 to get the scene-referred raw data Im2 from the film scanner 9. At the same time, it acquires the information on the image-capturing characteristics of the film scanner 9 used to capture the image, as image-capturing apparatus information In2. Further, when the original image Im1 is a digital image having been captured by a digital camera and others, and this digital image has been inputted through the image transfer section 30 or communications section for receiving 40, then the control section 12 controls the image data form processing section 4 to analyze the data structure of this digital image, and to get the scene-referred raw data Im2 and image-capturing apparatus information In2 at the same time.

It is also possible to arrange such a configuration that the control section 12 controls the scene-referred image data Im3 to get the scene-referred raw data Im2 and image-capturing apparatus information In2 from the image data inputted through the reflected document input apparatus 10.

It should be noted in passing that, if the image data is the scene-referred image data Im3 having been subjected to the processing of image-capturing characteristic compensation, the control section 12 goes to step S2004. Further, when information at the time of image capturing has been assigned, the control section 12 acquires the information as image-capturing information In3.

Step S2002

The control section 12 controls the image-capturing characteristic compensation processing section 103a to get reproduction data In4 for image-capturing characteristics compensation processing corresponding to the image-capturing apparatus information In2 from the processing condition table 103b.

Step S2003

Based on the scene-referred raw data Im2 and reproduction data In4 for image-capturing characteristics compensation processing, the control section 12 controls the scene-referred image data generation section 104 to generate the standardized scene-referred image data Im3.

Step S2004

The control section 12 controls the output device information processing section 108 to device information In5 for display recorded on the device database 109.

Step S2005

Based on the device information In5 for display, the control section 12 controls the rendering condition generation section 105 to set the rendering condition In6 compatible with the display device used in the next processing of generating the output-referred image data Im4 for display.

Step S2006

Based on the rendering condition In6 compatible with the display device, the control section 12 controls the output-referred image data generation section 107 to generate the output-referred image data Im4 for display.

It is also possible to arrange such a configuration that, in steps S2005 and S2006, repeated processing is carried out by changing the rendering condition and/or sequence of processing from the operation section 11 and control section 12 through the image adjustment processing section 1.

Step S2007

Based on the client order information In1, the control section 12 controls the output device information processing section 108 to determine that the reference output device is the photographic printer of an image processing service provider (exposure processing section 13). At the same time, it acquires the reference output device information In7 from the device database 109.

If no reference output device is specified by the client at the time of application for image processing services and acceptance of the application, it can be set as appropriate at the discretion of the image processing service provider, for example, by making reference to the past orders of the client in the client database (not illustrated) and setting the reference output device. Such a configuration can also be arranged.

Step S2008

Based on the obtained reference output device information In7, the control section 12 controls the rendering condition generation section 105 to set the rendering condition that is used in the next processing of generating reference output-referred image data Im5 compatible with the reference output device, i.e. the reference rendering information In8.

It should be noted that, when the image-capturing information In3 has been obtained, it is also possible to arrange such a configuration as to adjust the rendering condition in response to image-capturing information In3. Further, it is also possible to arrange such a configuration as to get a template image from the database or from the outside and to superimpose it onto the image to be processed.

Step S2009

Based on the reference rendering information In8, the control section 12 controls the output-referred image data generation section 107 to generate the reference output-referred image data Im5.

It is also possible to arrange such a configuration that, in steps S2008 and S2009, repeated processing is carried out, for example, by changing the rendering condition and/or sequence of processing.

Step S2010

Similarly to the cases of Steps S2008 and S2009, the control section 12 controls the rendering condition generation section 105 and sets rendering conditions different in the processing conditions and/or sequence of processing from the reference rendering information In8 compatible with the above-mentioned reference output device, (i.e. comparative rendering conditions In12), while the output device is the photographic printer (exposure processing section 13) of the image processing service provider as reference output device. Based on this comparative rendering conditions In12, comparative output-referred image data Im14 is generated.

It is also possible to arrange such a configuration that more than two comparative rendering conditions In12 are set to produce multiple pieces of corresponding comparative output-referred image data Im14.

Step S2011

Based on multiple pieces of comparative rendering conditions In12, the control section 12 controls the output-referred image data generation section 107 and generates multiple pieces of corresponding comparative output-referred image data Im14.

Step S2012

The control section 12 controls the printing information generation section 112, and acquires the reference output-referred image data Im5, comparative output-referred image data Im14 and rendering conditions corresponding to each piece of image data. Then it performs specified image reduction, trimming and other processing, and organizes the rendering conditions attached to the print image. It further generates reference image data Im15, and performs such processing as printer inherent calibration, color matching and change of the pixel count, as required.

Step S2013

The control section 12 controls the printer inherent processing section 7 and outputs the reference image data Im15 to the photographic printer of an image processing service provider (exposure processing section 13) as the reference output device, and creates the reference print Im16.

In this case, it is also possible to arrange such a configuration that client information (client ID, name, etc.), image information (image ID, etc.) and others are recorded as images readable to a human or machine. It is also possible to make such arrangements that the client information (client ID, name, etc.), image information (image ID, etc.) and others are printed on the surface and/or back of the reference print Im16, using the backup print function and others of the exposure processing section 13 (photographic print).

Step S2014

The control section 12 generates the information recorded as shown below:

(1) The control section 12 controls the recording information generation section 110 to generate the information for giving the reference rendering information In8 used for generation of the reference output-referred image data Im5 as reference rendering information In9.

When the reference rendering information In9 is recorded, it is also possible to arrange such a configuration that all processing items and processing conditions are recorded in the form associated with each other. Alternatively, it is also possible to make such arrangements as to record the items changed from the separately set standardized rendering conditions and/or differences in processing conditions.

(2) The control section 12 controls the recording information generation section 110 to generate the differential data of “reference output-referred image data Im5”—“output-referred image data Im4 for display” as differential data A Im6.

(3) The control section 12 controls the recording information generation section 110 to generate the differential data of “scene-referred image data Im3”—“reference output-referred image data Im5” as differential data B Im7.

Step S2015

The control section 12 controls the recording information generation section 110 to record the rendering processing program Pr2 for the client on the portable recording medium (not illustrated) stored in the image transfer unit 31.

Step S2016

The control section 12 controls the recording information generation section 110 to record the tag information-equipped output-referred image data for display Im8 wherein the reference rendering information In9, differential data A Im6 and differential data B Im7 are added to the header of the image file of the output-referred image data Im4 for display as tag information; wherein the tag information-equipped output-referred image data for display Im8 is recorded on the portable recording medium with the rendering processing program Pr2 for client recorded therein in Step S2015. In this case, it is also possible to record the image information In3 or the like as the tag information.

Subsequent to step S2016, the image processing service provider supplies the client with:

a portable recording medium that records the tag information-equipped output-referred image data for display Im8 that contains the reference rendering information In9, differential data A Im6, and differential data B Im7 as tag information and the rendering processing program Pr2 for client; and

a reference print Im16 comprising the rendering information corresponding to a reference print Im16 comprising an image based on reference output-referred image data Im5, an image based on comparative output-referred image data Im14 and each images. Further, the image processing service provider can send an additional bill in conformity to the data and program to be provided.

In the second embodiment, differential data A Im6 capable of reconfiguring the output-referred image data Im4 for display and reference output-referred image data Im5;

differential data B Im7 capable of reconfiguring the scene-referred image data Im3;

reference rendering information In9; and

rendering processing program Pr2 for client are recorded on one and the same portable recording medium and are supplied to the client. However, the present invention is not restricted to only these. Similarly to the case of the first embodiment, part of the above-mentioned information can be recorded on another portable recording medium, or part or whole of the above-mentioned information can be supplied to a client through the communications network.

The tag information-equipped output-referred image data for display Im8, wherein reference rendering information In9, differential data A Im6 and differential data B Im7 recorded in the portable recording medium in step S2016 are included as tag information in the header of the file of the output-referred image data Im4 for display, can be arranged in the same configuration as that of the first embodiment. Alternatively, it is also possible to make such arrangements that part or whole of tag information is recorded on a separate file, and link information is recorded as tag information so that files are linked with each other.

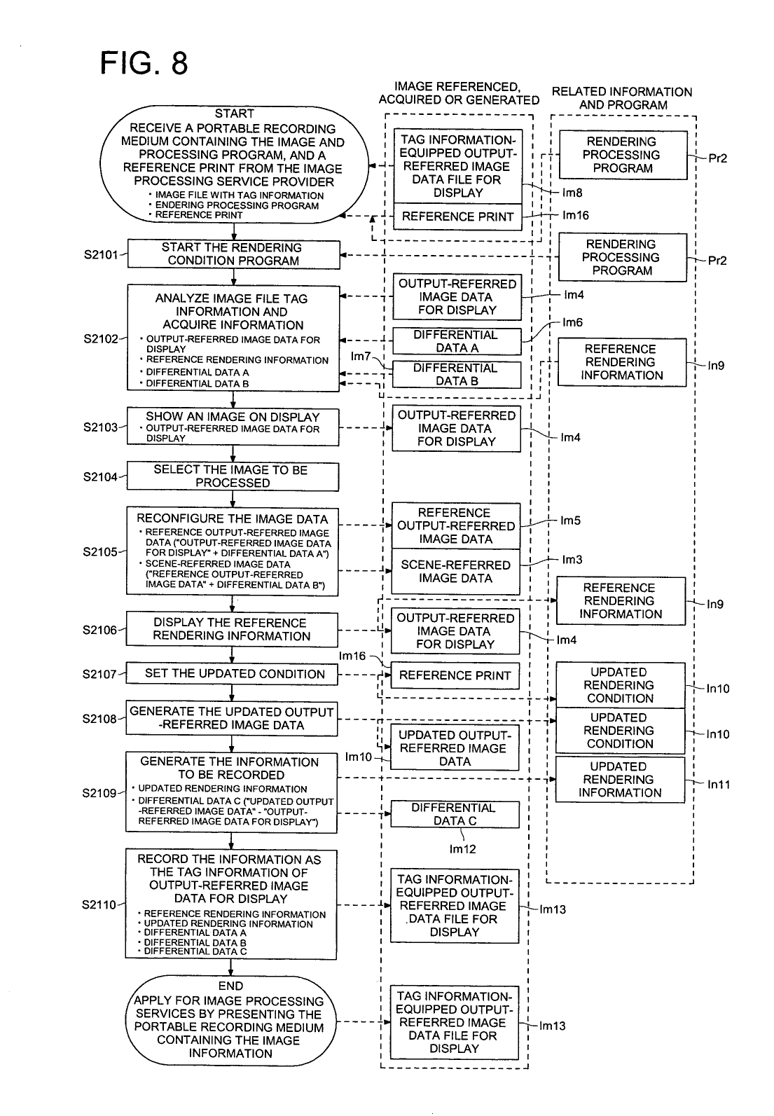

The following describes the processing of rendering based on the rendering processing program Pr2: FIG. 8 is a flowchart representing rendering processing based on the rendering processing program Pr2 for client. The processing of rendering shown in the flowchart is realized when the rendering processing program Pr2 provided by the image processing service provider is run by the above-mentioned CPU of the client (not illustrated) regularly used by the client.

FIG. 8 also shows the image, related information and program referenced, acquired or generated in each step of this flowchart.

In the first place, the client receives the portable recording medium recording the tag information-equipped output-referred image data for display Im8 and rendering processing program Pr2, and reference image data Im15 (i.e. the client loads or installs such data into his or her own PC).

Step S2102

The client CPU starts the received rendering processing program Pr2.

Step S2102

Based on the rendering processing program Pr2, the client CPU analyzes the tag information of the tag information-equipped output-referred image data for display Im8. Further, it acquires various types of information such as output-referred image data Im4 for display, reference rendering information In9, differential data A Im6 and differential data B Im7.

Step S2103

The client CPU displays the output-referred image data Im4 for display on the display section (not illustrated). In this case, it is preferred that the client CPU generate the thumbnail screen having a small pixel count as required, and display it. It is also preferred that the thumbnail image be generated by the image processing service provider and be recorded in the form associated with the information for giving scene-referred image data Im3 and reference rendering information In9. Further, it is also possible to make such arrangements that the thumbnail is recorded on the header of the tag information-equipped output-referred image data for display Im8 as tag information.

Step S2104

The client CPU receives the instruction for specifying the image to be processed as inputted by the client.

Step S2105

When the image to be processed has been specified, the client CPU reconfigures the image data used for this processing as shown below, based on the rendering processing program Pr2:

(1) The client CPU reconfigures the reference output-referred image data Im5 by merging the output-referred image data Im4 for display and differential data A Im6 with the reference output-referred image data Im5.

(2) It reconfigures the scene-referred image data Im3 by merging the reference output-referred image data Im5 with the differential data B Im7.

Step S2106

The client CPU displays the reference rendering information In9 in the form associated with the image to be processed.

Step S2107

Based on the instruction given by the client making reference to reference rendering information In9 given on the display, an image based on the reference output-referred image data Im5 printed on the reference print Im16, an image based on the comparative output-referred image data Im14, and rendering information corresponding to each image, the client CPU sets the rendering condition used to generate the updated output-referred image data Im10 for creating the print finished to meet the preferences of the client, namely, the updated rendering condition In10.

The reference rendering information In9 is displayed in the form corresponding to the image to be processed. At the same time, a reference print Im16 is displayed, where this print is created by inputting the image based on the reference output-referred image data Im5 and output-referred image data Im4 for display, and the rendering information corresponding to each image, to the photographic printer of an image processing service provider as the reference output device (exposure processing section 13). This allows the client to set the updated rendering condition In10 easily by making reference to them.

Step S2108

Based on the updated rendering condition In10, the client CPU applies image processing of rendering or the like to the scene-referred image data Im3, and generates new output-referred image data, i.e. updated output-referred image data Im10.

Step S2109

The client CPU generates the information recorded as shown below:

(1) The client CPU generates the updated rendering condition In10 as the updated rendering information In11.

When the updated rendering information In11 is recorded, it is also possible to arrange such a configuration that all processing items and processing conditions are recorded in the form associated with each other. Alternatively, it is also possible to make such arrangements as to record the items changed from the separately set standardized rendering conditions and/or differences in processing conditions. Alternatively, it is possible to record the items changed from the reference rendering information In9 and/or differences in processing conditions.

(2) The client CPU generates the differential data of “updated output-referred image data Im1”—“output-referred image data Im4 for display” as differential data C Im12.

Step S2110

The client CPU records the reference rendering information In9, updated rendering information In11, differential data A Im6, differential data B Im7 and differential data C Im12 as the tag information-equipped output-referred image data file Im13 for display where tag information is added on the header of the image file of the output-referred image data Im4 for display (see FIG. 5).

In this case, it is also possible to make such arrangements that image-capturing information In3 and others are also recorded. Further, it is also possible go back to the processing of Step S2107 at the discretion of the client and to reset the updated rendering condition In10.

Subsequent to Step S2111, the client re-records the tag information-equipped output-referred image data file Im13 for display created in step S2110 on the portable recording medium, as required, and requests the image processing service provider to provide image processing services directly or by mail by attaching this recording medium.

In response to the above-mentioned request for image processing service provider from the client, the image processing service provider outputs the updated output-referred image data Im10 to the photographic printer (exposure processing section 13) of the image processing service provider as reference output device, and creates the hardcopy print finished to meet the preference of the client.

When the hardcopy print created by outputting the updated output-referred image data Im10 to the photographic printer (exposure processing section 13) of the image processing service provider as reference output device has been finished to meet the client preference, it is also possible to arrange such a configuration that the client CPU records the updated rendering information In11 as reference rendering information In9. Alternatively, it is also possible to set the updated output-referred image data Im10 as new reference output-referred image data, and to record it.

When the updated output-referred image data Im10 is set and recorded as new reference output-referred image data, it is also possible to arrange such a configuration that the client CPU records scene-referred image data Im3, updated rendering information In11 and updated output-referred image data Im10 in the form associated with one another. Alternatively, it is also possible to find out the differential data D (not illustrated) of “scene-referred image data Im3”—“updated output-referred image data Im10”, and to record the updated rendering information In11, differential data C Im12 and differential data D as the tag information of tag information-equipped output-referred image data file Im13 for display. In this case, it is also possible to update the related data recorded on the data storage section 71 of the image processing service provider.

In the Step S2110, the same structure as that of the first embodiment shown in FIG. 5 may be assigned to the tag information-equipped output-referred image data file Im13 for display that is formed by attaching the reference rendering information In9, updated rendering information In11, differential data A Im6, differential data B Im7 and differential data C Im12 to the header of the image file of the output-referred image data Im4 for display as tag information. Alternatively, part or whole of the tag information can be written in a separate file.

In the present second embodiment, the client requests the image processing service provider to provide image processing services by presenting the portable recording medium recording the tag information-equipped output-referred image data file Im13 for display. However, this present invention is not restricted thereto. It is also possible to arrange such a configuration as to place an order for a print with the image processing service provider through the communications network of the Internet, etc., for example, by sending part of while of the information, order information and others in the form of an electronic mail and/or information attached thereto, or transferring it to a service site.

As described above, the reference rendering information In9 is displayed in the form corresponding to the image to be processed. At the same time, a reference print Im16 is displayed, where this print is created by inputting the image based on the reference output-referred image data Im5 and output-referred image data Im4 for display, and the rendering information corresponding to each image, to the photographic printer of an image processing service provider as the reference output device (exposure processing section 13). This allows the client to set the updated rendering condition In10 easily by making reference to them. The updated output-referred image data Im10 generated based on the updated rendering condition In10 is outputted from the photographic printer of an image processing service provider as the reference output device (exposure processing section 13). This allows the client to create a high-quality hardcopy print meeting his or her intention and preference.

It is also possible to make such arrangements that the information providing comparative rendering conditions In12, etc. and/or multiple pieces of comparative output-referred image data Im14 are provided to the client, and the rendering processing program Pr2 shows such information on the display, so that the client can select or set the rendering conditions.

It is also possible to make such arrangements as to supply a reference print Im16 (reference print and comparative print) recording the customer information, image ID, etc.) to the client unable to handle the image data of the present invention for lack of a computer. The client observes the reference print Im16 and specifies the image (details of processing) finished to meet his or her preference. When the client places an order for a print by presenting the reference print Im16, the image processing service provider acquires the corresponding to the ID recorded on the reference print Im16, from the data storage section 71, and reconfigures the scene-referred image data Im3. New output-referred image data is generated by processing including rendering based on the details of processing, i.e. the rendering information, and is outputted to the photographic printer of an image processing service provider as the reference output device (exposure processing section 13), thereby creating a high-quality hardcopy print meeting his or her intention and preference.

The present invention provides a client with the change of easily adjusting the image data reflected in a high-quality print, thereby creating a high-quality print finished to meet the client preference.

Disclosed embodiment can be varied by a skilled person without departing from the spirit and scope of the invention.

What is claimed is:

1. A method for providing processed image data to a client, who requests an image-processing service from an image-processing service provider, said processed image data being generated by processing an original image submitted by said client as an object of said image-processing service, so as to conform with device characteristics of an output device, said method comprising the steps of:
acquiring original image data, which include expanded color-range image data, from said original image;
determining a first optimizing condition, serving as a first rendering condition, for generating first output-referred image data from device characteristic data in respect to a first output device and said original image data including said expanded color-range image data, in order to generate first optimizing condition data;
storing said original image data including said expanded color-range image data and said first optimizing condition data, representing said first optimizing condition, while correlating them; and
providing said original image data including said expanded color-range image data and said first optimizing condition data, stored in said storing step, to said client, based on a providing procedure established in advance.

2. The method of claim 1,
wherein, in said storing step, said first optimizing condition data are stored as tag information of said expanded color-range image data.

3. The method of claim 1, further comprising the step of:
generating reduced image data, being suitable for said output device, from said original image data and either said first optimizing condition data or other optimizing condition data, so that a size of said reduced image data becomes smaller than that of said expanded color-range image data;
wherein, in said storing step, said reduced image data are stored while being correlated with said original image data and/or said first optimizing condition data.

4. The method of claim 3, further comprising the step of:
generating first differential image data, which represent a difference between said expanded color-range image data and said reduced image data;
wherein, in said storing step, said first differential image data are stored while being correlated with said reduced image data.

5. The method of claim 4,
wherein, in said storing step, said first differential image data are stored as tag information of said reduced image data.

6. The method of claim 1,
wherein said first output device is a printer equipped at said image-processing service provider or another print service provider.

7. The method of claim 1,
wherein said first output device is a printer equipped at a site of said client who requests said image-processing service from said image-processing service provider.

8. The method of claim 1, further comprising the step of:
setting an output device designated by said client as said first output device.

9. The method of claim 1, further comprising the step of:
generating said first output-referred image data from said original image data, based on said first optimizing condition;
wherein, in said storing step, said first output-referred image data are stored while being correlated with said original image data including said expanded color-range image data and/or said first optimizing condition data.

10. The method of claim 9,
wherein, in said storing step, said first optimizing condition data are stored as tag information of said first output-referred image data.

11. The method of claim 9, further comprising the step of:
generating second differential image data, which represent a difference between said expanded color-range image data and said first output-referred image data;
wherein, in said storing step, said second output-referred image data are stored while being correlated with said first output-referred image data.

12. The method of claim 9,
wherein, in said determining step, a second optimizing condition, serving as a second rendering condition, for generating second output-referred image data from second device characteristic data in respect to a second output device and said original image data including said expanded color-range image data, is determined; and
wherein, in said generating step, said second output-referred image data are generated from said original image data, based on said second optimizing condition; and
wherein, in said storing step, said first output-referred image data are stored while being correlated with said second output-referred image data.

13. The method of claim 12, further comprising the step of:
generating third differential image data, which represent a difference between said first output-referred image data and said second output-referred image data;
wherein, in said storing step, said third differential image data are stored while being correlated with said second output-referred image data.

14. The method of claim 1, further comprising the step of:
producing a first print having a first image formed on a printing medium by said first output device, based on said first output-referred image data;
wherein, during said producing step, said first output-referred image data are correlated with said original image data and said first optimizing condition.

15. The method of claim 14,
wherein, in said determining step, a third optimizing condition, which is different from said first optimizing condition in respect to at least one processing condition and/or a processing order, is determined; and
wherein, in said generating step, third output-referred image data are generated from said original image data, based on said third optimizing condition; and
wherein, in said producing step, said first output device produces a second print by forming a second image on said printing medium, based on said third output-referred image data.

16. The method of claim 15,
wherein, in said producing step, said first output device produces said second print by forming said second image on said printing medium, based on a difference between said first output-referred image data and said third output-referred image data.

17. The method of claim 15,
wherein, in said producing step, said first output device produces said second print by forming both said first image and said second image on said printing medium.

18. The method of claim 15,
wherein, in said producing step, said first output device produces said second print by forming a reduced image, which is obtained by reducing a third image formed from said third output-referred image data, on said printing medium.

19. The method of claim 15, further comprising the step of:
trimming a part of a third image formed from said third output-referred image data;
wherein, in said producing step, said first output device produces said second print by forming said third image, said part of which is trimmed in said trimming step, on said printing medium, based on said third output-referred image data.

20. The method of claim 1,
wherein, in said storing step, said original image data, including said expanded color-range image data, and said first optimizing condition data are stored in a computer-readable storage medium, while correlating them with each other.

21. The method of claim 1,
wherein, in said storing step, said original image data, including said expanded color-range image data, and said first optimizing condition data are stored in a server coupled to a communication network, while correlating them with each other.

22. The method of claim 1,
wherein, in said storing step, an optimization processing program, for acquiring a fourth optimizing condition, based on said original image data including expanded color-range image data and said first optimizing condition, is stored in a computer-readable storage medium.

23. The method of claim 22,
wherein, in said storing step, said optimization processing program, for generating and storing a fourth output-referred image data, based on said original image data including expanded color-range image data and said fourth optimizing condition data, is stored in said computer-readable storage medium.

24. The method of claim 23,
wherein, in said storing step, said optimization processing program, for storing said fourth output-referred image data while correlating said fourth output-referred image data with said original image data including said expanded color-range image data and/or said first optimizing condition data, is stored in said computer-readable storage medium.

25. The method of claim 22,
wherein, in said storing step, said optimization processing program, for storing said fourth optimizing condition data while correlating said fourth optimizing condition data with said original image data including said expanded color-range image data and/or said first optimizing condition data, is stored in said computer-readable storage medium.

26. The method of claim 1,
wherein, in said acquiring step, scene-referred image data, which are standardized from scene-referred raw data, including device characteristics of an image-capturing apparatus, by compensating for said device characteristics, are acquired as said expanded color-range image data; and
wherein, in said storing step, said scene-referred image data and said first optimizing condition are stored while being correlated with each other.

27. An apparatus for generating data, which are employed for acquiring processed image data suitable for device characteristics of an output device from an original image, in order to store said data in it, said apparatus comprising:
an acquiring section to acquire original image data, which include expanded color-range image data, from said original image;
a determining section to determine a first optimizing condition, serving as a first rendering condition, for generating first output-referred image data from device characteristic data in respect to a first output device and said original image data including said expanded color-range image data, in order to generate first optimizing condition data; and
a storing section to store said original image data including said expanded color-range image data and said first optimizing condition data, representing said first optimizing condition, while correlating them.

28. The apparatus of claim 27,
wherein said storing section stores said first optimizing condition data as tag information of said expanded color-range image data.

29. The apparatus of claim 27, further comprising:
a reduced image data generating section to generate reduced image data, being suitable for said output device, from said original image data and either said first optimizing condition data or other optimizing condition data, so that a size of said reduced image data becomes smaller than that of said expanded color-range image data;
wherein said storing section stores said reduced image data while correlating said reduced image data with said original image data and/or said first optimizing condition data.

30. The apparatus of claim 29, further comprising:
a first differential image data generating section to generate first differential image data, which represent a difference between said expanded color-range image data and said reduced image data;
wherein said storing section stores said first differential image data while correlating said first differential image data with said reduced image data.

31. The apparatus of claim 29,
wherein said storing section stores said first differential image data as tag information of said reduced image data.

32. The apparatus of claim 27,
wherein said first output device is a printer equipped at an image-processing service provider or another print service provider.

33. The apparatus of claim 27,
wherein said first output device is a printer equipped at a site of a client who requests an image-processing service from an image-processing service provider.

34. The apparatus of claim 27, further comprising:
an output device setting section to set an output device, designated by a client who requests an image-processing service from an image-processing service provider, as said first output device.

35. The apparatus of claim 27, further comprising:
an output-referred image data generating section to generate said first output-referred image data from said original image data, based on said first optimizing condition;
wherein said storing section stores said first output-referred image data while correlating said first output-referred image data with said original image data including said expanded color-range image data and/or said first optimizing condition data.

36. The apparatus of claim 35,
wherein said storing section stores said first optimizing condition data as tag information of said first output-referred image data.

37. The apparatus of claim 35, further comprising:
a differential image data generating section to generate second differential image data, which represent a difference between said expanded color-range image data and said first output-referred image data;
wherein said storing section stores said second output-referred image data while correlating said second output-referred image data with said first output-referred image data.

38. The apparatus of claim 35,
wherein said determining section determines a second optimizing condition, serving as a second rendering condition, for generating second output-referred image data from second device characteristic data in respect to a second output device and said original image data including said expanded color-range image data; and
wherein said output-referred image data generating section generates said second output-referred image data from said original image data, based on said second optimizing condition; and
wherein said storing section stores said first output-referred image data while correlating said first output-referred image data with said second output-referred image data.

39. The apparatus of claim 38, further comprising:
a differential image data generating section to generate third differential image data, which represent a difference between said first output-referred image data and said second output-referred image data;
wherein said storing section stores said third differential image data while correlating said third differential image data with said second output-referred image data.

40. The apparatus of claim 27, further comprising:
a print producing section to produce a first print having a first image formed on a printing medium by said first output device, based on said first output-referred image data;
wherein, during producing said first print, said print producing section correlates said first output-referred image data with said original image data and said first optimizing condition.

41. The apparatus of claim 40,
wherein said determining section determines a third optimizing condition, which is different from said first optimizing condition in respect to at least one processing condition and/or a processing order; and
wherein said output-referred image data generating section generates third output-referred image data from said original image data, based on said third optimizing condition; and
wherein said print producing section makes said first output device to produce a second print by forming a second image on said printing medium, based on said third output-referred image data.

42. The apparatus of claim 41,
wherein said print producing section makes said first output device to produce said second print by forming said second image on said printing medium, based on a difference between said first output-referred image data and said third output-referred image data.

43. The apparatus of claim 41,
wherein said print producing section makes said first output device to produce said second print by forming both said first image and said second image on said printing medium.

44. The apparatus of claim 41,
wherein said print producing section makes said first output device to produce said second print by forming a reduced image, which is obtained by reducing a third image formed from said third output-referred image data, on said printing medium.

45. The apparatus of claim 41, further comprising:
a trimming section to trim a part of a third image formed from said third output-referred image data;
wherein said print producing section makes said first output device to produce said second print by forming said third image, said part of which is trimmed by said trimming section, on said printing medium, based on said third output-referred image data.

46. The apparatus of claim 27,
wherein said storing section stores said original image data, including said expanded color-range image data, and said first optimizing condition data in a computer-readable storage medium, while correlating them with each other.

47. The apparatus of claim 27,
wherein said storing section stores said original image data, including said expanded color-range image data, and said first optimizing condition data in a server coupled to a communication network, while correlating them with each other.

48. The apparatus of claim 27,
wherein said storing section stores an optimization processing program, for acquiring a fourth optimizing condition, based on said original image data including expanded color-range image data and said first optimizing condition, in a computer-readable storage medium.

49. The apparatus of claim 48,
wherein said storing section stores said optimization processing program, for generating and storing a fourth output-referred image data, based on said original image data including expanded color-range image data and said fourth optimizing condition data, in said computer-readable storage medium.

50. The apparatus of claim 49,
wherein said storing section stores said optimization processing program, for storing said fourth output-referred image data while correlating said fourth output-referred image data with said original image data including said expanded color-range image data and/or said first optimizing condition data, in said computer-readable storage medium.

51. The apparatus of claim 48,
wherein said storing section stores said optimization processing program, for storing said fourth optimizing condition data while correlating said fourth optimizing condition data with said original image data including said expanded color-range image data and/or said first optimizing condition data, in said computer-readable storage medium.

52. The apparatus of claim 1,
wherein said acquiring section acquires scene-referred image data, which are standardized from scene-referred raw data including device characteristics of an image-capturing apparatus by compensating for said device characteristics, as said expanded color-range image data; and
wherein said storing section stores said scene-referred image data and said first optimizing condition while correlating them with each other.

53. A computer program for executing controlling-operations for generating and storing data, which are employed for acquiring processed image data suitable for device characteristics of an output device from an original image, said computer program comprising the functional steps of:
acquiring original image data, which include expanded color-range image data, from said original image;
determining a first optimizing condition, serving as a first rendering condition, for generating first output-referred image data from device characteristic data in respect to a first output device and said original image data including said expanded color-range image data, in order to generate first optimizing condition data; and
storing said original image data including said expanded color-range image data and said first optimizing condition data, representing said first optimizing condition, while correlating them.

54. The computer program of claim 53,
wherein, in said storing step, said first optimizing condition data are stored as tag information of said expanded color-range image data.

55. The computer program of claim 53, further comprising the functional step of:
generating reduced image data, being suitable for said output device, from said original image data and either said first optimizing condition data or other optimizing condition data, so that a size of said reduced image data becomes smaller than that of said expanded color-range image data;
wherein, in said storing step, said reduced image data are stored while being correlated with said original image data and/or said first optimizing condition data.

56. The computer program of claim 55, further comprising the functional step of:
generating first differential image data, which represent a difference between said expanded color-range image data and said reduced image data;
wherein, in said storing step, said first differential image data are stored while being correlated with said reduced image data.

57. The computer program of claim 56,
wherein, in said storing step, said first differential image data are stored as tag information of said reduced image data.

58. The computer program of claim 53,
wherein said first output device is a printer equipped at an image-processing service provider or another print service provider.

59. The computer program of claim 53,
wherein said first output device is a printer equipped at a site of a client who requests an image-processing service from an image-processing service provider.

60. The computer program of claim 53, further comprising the functional step of:
setting an output device designated by said client as said first output device.

61. The computer program of claim 53, further comprising the functional step of:
generating said first output-referred image data from said original image data, based on said first optimizing condition;
wherein, in said storing step, said first output-referred image data are stored while being correlated with said original image data including said expanded color-range image data and/or said first optimizing condition data.

62. The computer program of claim 61,
wherein, in said storing step, said first optimizing condition data are stored as tag information of said first output-referred image data.

63. The computer program of claim 61, further comprising the functional step of:
generating second differential image data, which represent a difference between said expanded color-range image data and said first output-referred image data;
wherein, in said storing step, said second output-referred image data are stored while being correlated with said first output-referred image data.

64. The computer program of claim 61,
wherein, in said determining step, a second optimizing condition, serving as a second rendering condition, for generating second output-referred image data from second device characteristic data in respect to a second output device and said original image data including said expanded color-range image data, is determined; and
wherein, in said generating step, said second output-referred image data are generated from said original image data, based on said second optimizing condition; and
wherein, in said storing step, said first output-referred image data are stored while being correlated with said second output-referred image data.

65. The computer program of claim 64, further comprising the functional step of:
generating third differential image data, which represent a difference between said first output-referred image data and said second output-referred image data;
wherein, in said storing step, said third differential image data are stored while being correlated with said second output-referred image data.

66. The computer program of claim 53, further comprising the functional step of:
producing a first print having a first image formed on a printing medium by said first output device, based on said first output-referred image data;
wherein, during said producing step, said first output-referred image data are correlated with said original image data and said first optimizing condition.

67. The computer program of claim 66,
wherein, in said determining step, a third optimizing condition, which is different from said first optimizing condition in respect to at least one processing condition and/or a processing order, is determined; and
wherein, in said generating step, third output-referred image data are generated from said original image data, based on said third optimizing condition; and
wherein, in said producing step, said first output device produces a second print by forming a second image on said printing medium, based on said third output-referred image data.

68. The computer program of claim 67,
wherein, in said producing step, said first output device produces said second print by forming said second image on said printing medium, based on a difference between said first output-referred image data and said third output-referred image data.

69. The computer program of claim 67,
wherein, in said producing step, said first output device produces said second print by forming both said first image and said second image on said printing medium.

70. The computer program of claim 67,
wherein, in said producing step, said first output device produces said second print by forming a reduced image, which is obtained by reducing a third image formed from said third output-referred image data, on said printing medium.

71. The computer program of claim 67, further comprising the step of:
trimming a part of a third image formed from said third output-referred image data;
wherein, in said producing step, said first output device produces said second print by forming said third image, said part of which is trimmed in said trimming step, on said printing medium, based on said third output-referred image data.

72. The computer program of claim 53,
wherein, in said storing step, said original image data, including said expanded color-range image data, and said first optimizing condition data are stored in a computer-readable storage medium, while correlating them with each other.

73. The computer program of claim 53,
wherein, in said storing step, said original image data, including said expanded color-range image data, and said first optimizing condition data are stored in a server coupled to a communication network, while correlating them with each other.

74. The computer program of claim 53,
wherein, in said storing step, an optimization processing program, for acquiring a fourth optimizing condition, based on said original image data including expanded color-range image data and said first optimizing condition, is stored in a computer-readable storage medium.

75. The computer program of claim 74,
wherein, in said storing step, said optimization processing program, for generating and storing a fourth output-referred image data, based on said original image data including expanded color-range image data and said fourth optimizing condition data, is stored in said computer-readable storage medium.

76. The computer program of claim 75,
wherein, in said storing step, said optimization processing program, for storing said fourth output-referred image data while correlating said fourth output-referred image data with said original image data including said expanded color-range image data and/or said first optimizing condition data, is stored in said computer-readable storage medium.

77. The computer program of claim 74,
wherein, in said storing step, said optimization processing program, for storing said fourth optimizing condition data while correlating said fourth optimizing condition data with said original image data including said expanded color-range image data and/or said first optimizing condition data, is stored in said computer-readable storage medium.

78. The computer program of claim 53,
wherein, in said acquiring step, scene-referred image data, which are standardized from scene-referred raw data, including device characteristics of an image-capturing apparatus, by compensating for said device characteristics, are acquired as said expanded color-range image data; and
wherein, in said storing step, said scene-referred image data and said first optimizing condition are stored while being correlated with each other.
